(19) United States
(12) Patent Application Publication
(10) Pub. No.: US 2008/0231649 A1
(43) Pub. Date: Sep. 25, 2008

(54) IMAGE FORMING APPARATUS, METHOD FOR CORRECTING DISPLACEMENT OF LANDING POSITIONS

(76) Inventors: Kenichi KAWABATA, Kanagawa (JP); Noboru Sawayama, Kanagawa (JP); Tetsuro Hirota, Kanagawa (JP); Mamoru Yorimoto, Tokyo (JP); Tetsu Morino, Kanagawa (JP); Takumi Hagiwara, Aichi (JP)

Correspondence Address: COOPER & DUNHAM, LLP, 1185 AVENUE OF THE AMERICAS, NEW YORK, NY, 10036, US

(21) Appl. No.: 12/048,729

(22) Filed: Mar. 14, 2008

(30) Foreign Application Priority Data
Mar. 19, 2007 (JP) 2007-070404

(51) Int. Cl. B41J 29/38; B41J 29/393

(52) U.S. Cl. 347/14; 347/19

(57) ABSTRACT

A disclosed image forming apparatus for forming an image on a recording medium being conveyed includes: a recording head discharging droplets; a pattern forming unit forming an adjustment pattern for detecting displacement of landing positions of droplets on a water-repellent member, the adjustment pattern including a minimum block pattern for each detection item and being formed with plural droplets independent of one another; a reading unit including a light emitting unit projecting a light onto the adjustment pattern and a light receiving unit receiving a regular reflection light from the adjustment pattern; and a landing position correcting unit correcting the landing positions of the droplets discharged from the recording head based on a result of reading by the reading unit.

### BACKGROUND OF THE INVENTION

1. Field of the Invention

The present invention relates to an image forming apparatus including a recording head for discharging droplets and a method for correcting landing positions of droplets discharged from the recording head.

2. Description of the Related Art

Some image forming apparatuses such as printers, facsimile machines, copying machines, multifunction devices including these elements employ a liquid discharging device including a recording head having a liquid discharging head (droplet discharging head) discharging droplets of recording liquid (liquid), for example, and perform image formation (recording, printing, image printing, and character printing are used as having the same definition) by attaching the recording liquid which is a liquid (hereafter also referred to as ink) to paper while conveying a medium (hereafter such a medium is also referred to as “paper”, but use of the word is not intended to limit materials and a recorded medium, recording medium, transfer material, recording paper, and the like are used as having the same definition).

The image forming apparatus refers to a device for performing image formation by discharging a liquid to a medium such as paper, string, fiber, cloth, leather, metal, plastic, glass, wood, ceramics, and the like. And “image formation” refers not only to providing an image having a meaning such as a character, figure, and the like to a medium but to providing an image having no meaning such as a pattern to a medium, so that a textile printing device and a device for forming metal wiring are included in image forming apparatuses. Further, a liquid is not limited in particular as long as such a liquid is capable of being used for performing image formation.

In the image forming apparatus of this liquid discharging type, when a carriage on which the recording head discharging droplets is installed is oscillated and printing is performed bidirectionally in a going path and a returning path in particular, if a printing image is ruled lines, there is a problem in that displacement of positions of the ruled lines is likely to be generated in the going path and the returning path. Further, when an image is formed by superposing different colors, there is a problem in that color displacement is generated due to displacement of landing positions of each color.

Accordingly, in general, in ink-jet recording devices, a test chart for adjusting positional displacement of the ruled lines is manually output, a user selects and inputs an optimum value, and discharge timing is adjusted based on a result of the input, for example. However, an appearance of the test chart is different depending on individuals and an error of data input or the like may be generated from unaccustomed operation, so that this may invite failure of adjustment to the contrary.

Conventionally, in order to correct unevenness of density in the image forming apparatuses of the liquid discharging type, Patent Document 1 discloses correction of unevenness of density performed by printing a test pattern on a recording medium, a conveying belt, and the like, reading color data of the test pattern, and changing driving conditions of the head based on a result of the reading.

Patent Document 1: Japanese Laid-Open Patent Application No. 4-39041

Further, in order to detect nozzle failure in the liquid discharging head, Patent Document 2 discloses detection of failure of a discharge nozzle performed by forming a test pattern having dots of mixed colors made of cyan ink, magenta ink, and yellow ink in a predetermined field on a member holding and conveying a printing medium, reading the mixed dots using an RGB sensor, and detecting nozzle failure based on a result of the reading.

Patent Document 2: Japanese Patent Publication No. 3838251.

Further, Patent Document 3 discloses correction performed by recording a test pattern made of any one of or a combination of a nozzle failure pattern for detecting nozzle failure, a color displacement pattern for detecting color displacement of ink, and a head position adjustment pattern for adjusting a position of the recording head on a portion of a conveying belt, reading the test pattern using an imaging unit such as CCD and the like, and performing correction based on a result of the reading.

Patent Document 3: Japanese Laid-Open Patent Application No. 2005-342899

On the other hand, in an electrophotographic image forming apparatus using toner, in order to detect density of a toner image, Patent Document 4 discloses an apparatus including a light emitting element and light receiving elements for forming a toner image on a photoconductor drum and for detecting the density of the toner image in which one light receiving element receives a regular reflection light and the other light receiving element receives a scattered light, and the density of the toner image is separately detected by the light receiving elements having different characteristics.

Patent Document 4: Japanese Laid-Open Patent Application No. 5-249787

Further, Patent Document 5 discloses an apparatus for detecting an amount of attached toner using an output obtained as a result of detection using a sensor capable of detecting a regular reflection light and a scattered light at once from a formed toner image.

Patent Document 5: Japanese Laid-Open Patent Application No. 2006-178396

However, as disclosed in the above-mentioned Patent Documents 1 to 3, when the test pattern is formed on the conveying belt so as to detect or image a color of the test pattern, there is a problem in that a difference of colors is small and accurate reading is difficult depending on a combination of a color of the conveying belt and a color of ink, for example. In this case, in order to accurately detect the colors, light sources whose wavelengths are changed in each color are used, for example. Accordingly, an expensive detection unit must be used and this poses a problem. For example, when an electrostatic belt is used as the conveying belt formed with an insulating layer in a front surface and a middle-resistive layer in a rear surface, and carbon is incorporated so as to obtain conductivity of the middle-resistive layer, a color of the electrostatic belt is black in appearance. Accordingly, when the test pattern is to be detected through simple reflection of color or imaging using an imaging unit, it is difficult to distinguish the color of the electrostatic belt from black ink, so that high accuracy detection is not performed.

Specifically, in the apparatus for correcting unevenness of density disclosed in Patent Document 1, the reading of color is performed using a sensor. In accordance with this, as the color of ink droplets to be discharged and the color of a member holding and conveying a medium are similar, detection accuracy is reduced. And each color is required to pass through a filter, so that types of the sensor and the filter are increased. Accordingly, cost of the apparatus is increased. Further, in the apparatus for detecting nozzle failure disclosed in Patent Document 2, the RGB sensor is used, so that when the color of ink droplets to be discharged and the color of the member holding and conveying a medium are similar, detection accuracy is reduced. When the detection accuracy is to be improved, a combination of ink to be used and a conveying member is limited. Further, when a laser light is used, an extremely limited point is scanned, so that the laser light is likely to be influenced by a small foreign substance and a flaw on the conveying member. Accordingly, the detection accuracy is reduced. The RGB sensor requires a unit for reading at least each color, so that cost is increased. In the apparatus employing the imaging unit disclosed in Patent Document 3, in the same manner as in Patent Document 2, when the detection accuracy is reduced when the color of the ink droplets to be discharged and the color of the member holding and conveying a medium are similar. Further, an image is recognized as a two-dimensional image, so that a relatively high-performance processing system is necessary in composition with a one-dimensional image. Accordingly, cost of the apparatus is increased.

In view of this, application of a method for detecting the amount of attached toner in the electrophotographic image forming apparatus disclosed in Patent Documents 4 and 5 is considered. A shape of toner is maintained when powder tone is brought into contact with each other, so that it is possible to read a portion where the toner is thickened on a rectangular line. When this is applied to a liquid-discharging image forming apparatus, droplets are coagulated. Accordingly, although detection is possible, only a level having not much difference from a noise is obtained, so that it is impossible to detect the test pattern with high detection accuracy.

When the test pattern is formed on what is called plain paper as a recorded medium into which ink is permeated and the test pattern is read using an optical sensor, ink bleeding may be generated due to permeation, so that the test pattern is blurred. Accordingly, it is impossible to accurately detect landing positions of the ink.

Moreover, when plural recording heads for discharging droplets of the same color are installed and printing is performed in the going path and the returning path, landing positions are more likely to be displaced between the recording heads of the same color than landing displacement resulting from a single recording head in the going path and the returning path. Accordingly, such plural heads discharging droplets of the same color requires correction of displacement of landing positions with higher accuracy.

### SUMMARY OF THE INVENTION

It is a general object of the present invention to provide an improved and useful image forming apparatus in which the above-mentioned problems are eliminated.

A more specific object of the present invention is to provide an image forming apparatus that can highly accurately detect an adjustment pattern for correcting displacement of landing positions formed with droplets and can perform highly accurate detection of landing positions and highly accurate correction of displacement of the landing positions.

According to one aspect of the present invention, there is provided an image forming apparatus for forming an image on a recording medium being conveyed, comprising: a recording head discharging droplets; a pattern forming unit forming an adjustment pattern for detecting displacement of landing positions of droplets on a water-repellent member, the adjustment pattern including a minimum block pattern for each detection item and being formed with plural droplets independent of one another; a reading unit including a light emitting unit projecting a light onto the adjustment pattern and a light receiving unit receiving a regular reflection light from the adjustment pattern; and a landing position correcting unit correcting the landing positions of the droplets discharged from the recording head based on a result of reading by the reading unit.

In the image forming apparatus according to the above-mentioned invention, preferably, the minimum block pattern for each detection item is a pattern for detecting displacement of a ruled line or displacement of color relative to a reference. Further, preferably, a plurality of the block patterns for each detection item are formed and arranged in a width direction of a printable field.

In the image forming apparatus according to the above-mentioned invention, the block pattern may be read by the reading unit in each formation of the block pattern. Further, the block pattern may be read by the reading unit plural times in each formation of the block pattern.

In the image forming apparatus according to the above-mentioned invention, a reading speed of the reading unit may be variably controlled. In this case, preferably, the reading speed is controlled in accordance with a formation position of the block pattern.

In the image forming apparatus according to the above-mentioned invention, the reading speed of the reading unit may be the same as a speed for forming the adjustment pattern. In this case, preferably, a reading field of the reading unit is positioned within a width of an image formation field of the recording head in a conveying direction of the water-repellent member and the reading field of the reading unit is positioned within a width of the adjustment pattern in the conveying direction of the water-repellent member.

In the image forming apparatus according to the above-mentioned invention, the reading unit may perform scanning together with the recording head and may be disposed upstream in a scanning direction of the recording head. In this case, preferably, a reading direction of the reading unit is unidirectional.

In the image forming apparatus according to the above-mentioned invention, the reading unit may perform scanning together with the recording head and is disposed upstream and downstream in a scanning direction of the recording head. In this case, preferably, a reading direction of the reading unit is bidirectional.

In the image forming apparatus according to the above-mentioned invention, the adjustment pattern may be read plural times by the reading unit. In this case, preferably, while the adjustment pattern is read plural times, a reading position is shifted at least once.

In the image forming apparatus according to the above-mentioned invention, the water-repellent member may be a conveying belt conveying the recording medium.

According to another aspect of the present invention, there is provided a method for correcting displacement of landing positions of droplets discharged from a recording head, comprising the steps of: forming an adjustment pattern for detecting the displacement of landing positions of the droplets on a water-repellent member, the adjustment pattern including a minimum block pattern for each detection item and being formed with plural droplets independent of one another; projecting a light onto the adjustment pattern and receiving a regular reflection light from the adjustment pattern to read the adjustment pattern; and correcting the landing positions of the droplets discharged from the recording head based on a result of the reading by the reading unit.

In the image forming apparatus according to the present invention and the method for correcting displacement of landing positions of droplets according to the present invention, the adjustment pattern for detecting the displacement of landing positions of the droplets is formed on the water-repellent member, the adjustment pattern including a minimum block pattern for each detection item and being formed with plural droplets independent of one another. A light is projected onto the adjustment pattern and a regular reflection light is received from the adjustment pattern to read the adjustment pattern. And the landing positions of the droplets discharged from the recording head are corrected based on a result of the reading by the reading unit. Thus, it is possible to detect the landing positions of droplets with high accuracy using a simple structure and to correct the displacement of the landing positions with high accuracy.

Other objects, features and advantage of the present invention will become more apparent from the following detailed description when read in conjunction with the accompanying drawings.

### BRIEF DESCRIPTION OF THE DRAWINGS

FIG. 1 is a schematic diagram showing an entire structure of an image forming apparatus according to the present invention;

FIG. 2 is a plan view illustrating an image forming unit and a sub-scanning conveying unit of an image forming apparatus;

FIG. 3 is a front view illustrating a sub-scanning conveying unit in a partial perspective view;

FIG. 4 is a cross-sectional view showing an example of a conveying belt;

FIG. 5 is a block diagram schematically illustrating a control unit;

FIG. 6 is a block diagram showing functions relating to detection of droplet landing positions and correction of droplet landing positions according to a first embodiment of the present invention;

FIG. 7 is a block diagram showing functions of a specific example relating to detection of droplet landing positions and correction of droplet landing positions;

FIG. 8 is a diagram illustrating an example of an adjustment pattern;

FIG. 9 is a diagram illustrating a pattern reading sensor;

FIG. 10 is a diagram illustrating diffusion of light from a droplet relating to pattern detection;

FIG. 11 is a diagram illustrating diffusion of light from a droplet when the droplet is flattened;

FIG. 12 is a diagram illustrating time elapsed from droplet landing and a change of voltage output from a sensor;

FIG. 13 is a schematic view illustrating an adjustment pattern according to the present invention;

FIG. 14 is a schematic view illustrating an adjustment pattern according to a comparative example;

FIG. 15 is a schematic view illustrating a comparative description when toner is used;

FIG. 16 is a diagram illustrating a first example of a process for detecting a position of an adjustment pattern;

FIG. 17A is a diagram illustrating a second example of a process for detecting a position of an adjustment pattern;

FIG. 17B is a diagram illustrating a second example of a process for detecting a position of an adjustment pattern;

FIG. 18 is a diagram illustrating a third example of a process for detecting a position of an adjustment pattern;

FIG. 19 is a diagram illustrating a first example of shapes of landed droplets forming an adjustment pattern;

FIG. 20A is a diagram illustrating a second example of shapes of landed droplets forming an adjustment pattern;

FIG. 20B is a diagram illustrating a second example of shapes of landed droplets forming an adjustment pattern;

FIG. 21A is a diagram illustrating a third example of shapes of landed droplets forming an adjustment pattern;

FIG. 21B is a diagram illustrating a third example of shapes of landed droplets forming an adjustment pattern;

FIG. 22A is a diagram illustrating an example of an arrangement pattern of droplets forming an adjustment pattern;

FIG. 22B is a diagram illustrating an example of an arrangement pattern of droplets forming an adjustment pattern;

FIG. 22C is a diagram illustrating an example of an arrangement pattern of droplets forming an adjustment pattern;

FIG. 23 is a diagram illustrating a droplet contact area in a detection range;

FIG. 24 is a diagram approximately showing an experimental result of a relationship between a percentage of a diffuse reflection area and a detection output;

FIG. 25 is a diagram schematically illustrating a droplet relating to diffuse reflectance of a pattern;

FIG. 26 is a diagram illustrating a contact angle of a droplet;

FIG. 27A is a diagram illustrating a block pattern;

FIG. 27B is a diagram illustrating a block pattern;

FIG. 27C is a diagram illustrating a block pattern;

FIG. 27D is a diagram illustrating a block pattern;

FIG. 28 is a diagram illustrating a ruled line adjustment pattern;

FIG. 29A is a diagram illustrating a color displacement adjustment pattern;

FIG. 29B is a diagram illustrating a color displacement adjustment pattern;

FIG. 30 is a diagram illustrating a position where an adjustment pattern is formed;

FIG. 31 is a flowchart illustrating a process for adjusting (correcting) displacement of landing positions of droplets;

FIG. 32 is a diagram illustrating a position of an adjustment pattern and a reading speed;

FIG. 33 is a plan view illustrating an example of a carriage and an installed reading sensor;

FIG. 34 is a plan view illustrating an example of two carriages and an installed reading sensor;

FIG. 35 is a flowchart illustrating a process for performing unidirectional printing and unidirectional reading with one reading sensor;

FIG. 36 is a flowchart illustrating a process for performing bidirectional printing and bidirectional reading with two reading sensors;

FIG. 37 is a flowchart illustrating a process for performing bidirectional reading on one block pattern regardless of a printing direction;

FIG. 38 is a flowchart illustrating a process for performing plural readings rotating a conveying belt; and

FIG. 39 is a diagram illustrating plural reading.

### DETAILED DESCRIPTION OF THE PREFERRED EMBODIMENTS

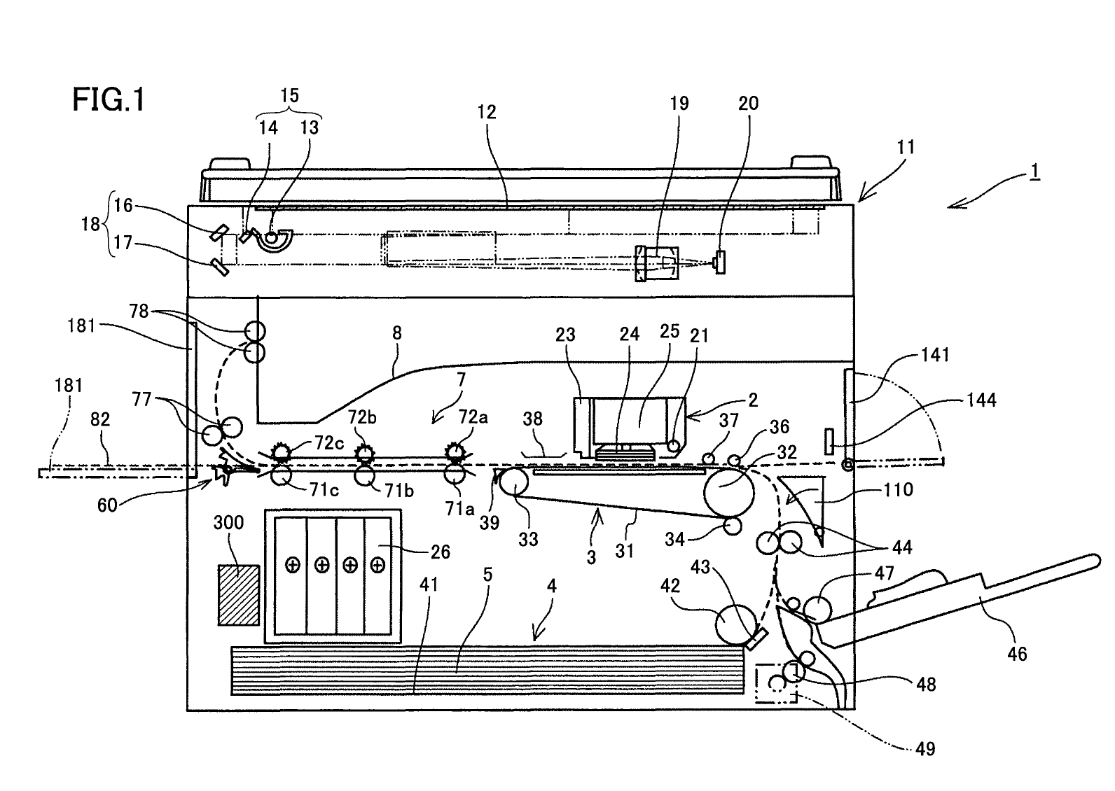

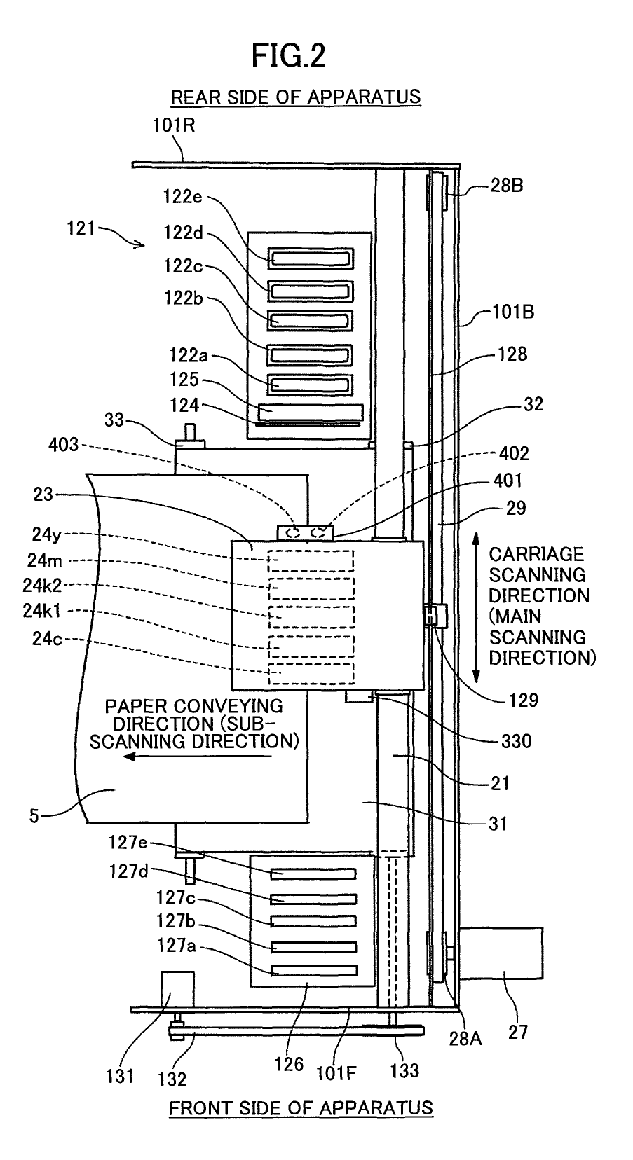

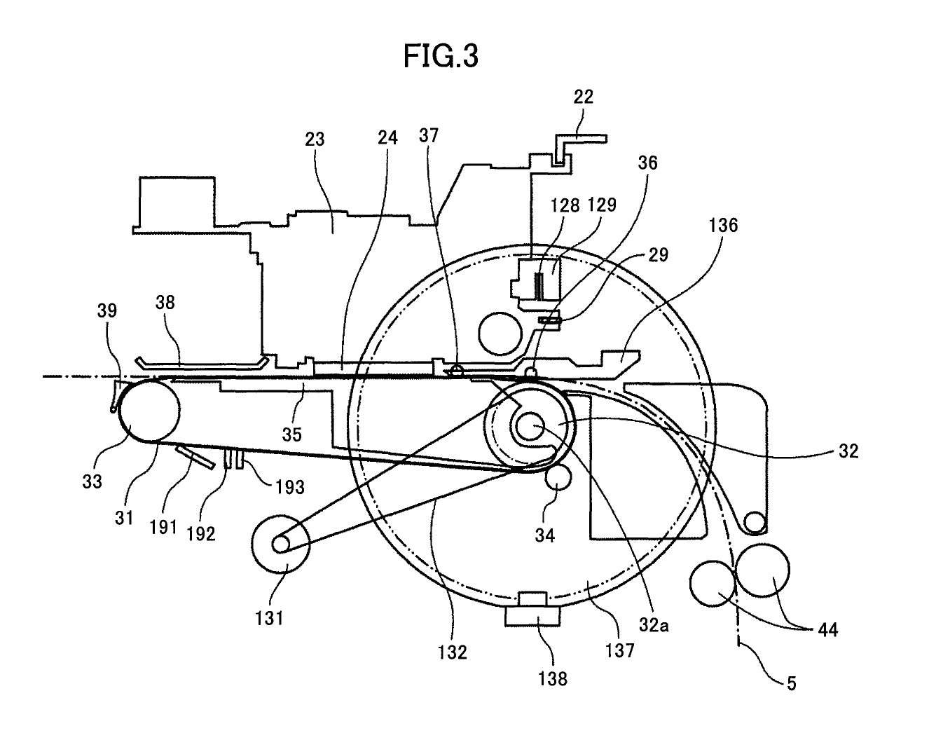

In the following, embodiments of the present invention will be described with reference to the accompanying drawings. An example of an image forming apparatus according to the present invention is described with reference to FIGS. 1 to 3. FIG. 1 is a schematic diagram showing an entire structure of the image forming apparatus. FIG. 2 is a plan view illustrating an image forming unit and a sub-scanning conveying unit of the image forming apparatus. FIG. 3 is a front view illustrating the sub-scanning conveying unit in a partial perspective view.

The image forming apparatus includes an apparatus body 1 (casing), an image forming unit 2 forming an image while paper is conveyed, a sub-scanning conveying unit 3 conveying the paper, and the like in the apparatus body 1. The image forming apparatus feeds paper 5 one by one from a paper feed unit 4 including a paper feed cassette disposed on a bottom of the apparatus body 1. The image forming apparatus forms (records) a required image by discharging droplets onto the paper 5 using the image forming unit 2 while conveying the paper 5 using the sub-scanning conveying unit 3 at a position facing the image forming unit 2, and then ejects the paper 5 onto a paper ejection tray 8 formed on a top surface of the apparatus body 1 through a paper ejection conveying unit 7.

Further, the image forming apparatus includes an image reading unit (scanner unit) 11 reading an image above the paper ejection tray 8 in an upper portion of the apparatus body 1 as an input system for image data (printing data) formed in the image forming unit 2. In the image reading unit 11, a scanning optical system 15 including an illumination source 13 and a mirror 14 and a scanning optical system 18 including a mirror 16 and a mirror 17 move to read an image of a document placed on a contact glass 12. The scanned image of the document is read as an image signal in an image reading element 20 disposed behind a lens 19. The read image signal is digitized and subjected to image processing and printing data obtained form the image processing is printed.

In this case, as shown in FIG. 2, the image forming unit 2 of the image forming apparatus holds a carriage 23 movably in a main scanning direction in a cantilevered manner using a guide rod 21 and a guide rail not shown in the drawings. The image forming unit 2 moves the carriage 23 so as to perform scanning in the main scanning direction using a main scanning motor 27 via a timing belt 29 stretched and installed between a driving pulley 28A and a driven pulley 28B.

As shown in FIG. 2, the image forming unit 2 of the image forming apparatus movably holds the carriage 23 in the main scanning direction using the carriage guide (guide rod) 21 as a main guide member laterally installed between a front side plate 101F and a rear side plate 101R and a guide stay 22 as a guided member disposed on a rear stay 101B. The image forming unit 2 moves the carriage 23 so as to perform scanning in the main scanning direction using the main scanning motor 27 via the timing belt 29 stretched and installed between the driving pulley 28A and the driven pulley 28B.

A total of five droplet discharging heads are installed on the carriage 23, including recording heads 24k1 and 24k2 having two droplet discharging heads each discharging black (K) ink and recording heads 24c, 24m, 24y each having one droplet discharging head discharging cyan (C) ink, magenta (M) ink, and yellow (Y) ink (hereafter referred to as “recording heads 24” unless color is specified or recording heads are collectively described). The carriage 23 is of a shuttle type in which the carriage 23 is moved in the main scanning direction and droplets are discharged from the recording heads 24 so as to form an image while the paper 5 is shifted in a paper-conveying direction (sub-scanning direction) using the sub-scanning conveying unit 3.

Further, a subtank 25 is installed on the carriage 23 so as to provide each of the recording heads 24 with recording liquid of a required color. On the other hand, as shown in FIG. 1, it is possible to detachably install an ink cartridge 26 of each color as a recording liquid cartridge containing each of the black (K) ink, cyan (C) ink, magenta (M) ink, and yellow (Y) ink on a cartridge installation unit 26A from a front side of the apparatus body 1 so as to supply the subtank 25 of each color with the inks (recording liquid) from the ink cartridge 26 of each color via a tube not shown in the drawings. In addition, the black ink is supplied from one ink cartridge 26 to two subtanks 25.

The recording heads 24 may employ what is called a piezo type in which a piezoelectric element is used as a pressure generating unit (actuator unit) pressurizing ink in an ink passage (pressure generating chamber), an vibrating plate forming a wall surface of the ink passage is deformed, and a volume in the ink passage is changed, thereby discharging ink droplets. Further, the recording heads 24 may employ what is called a thermal type in which a heat element is used, ink is heated in the ink passage, and air bubbles are generated, thereby discharging ink droplets from pressure upon generation of the air bubbles. Further, the recording heads 24 may employ what is called electrostatic type in which the vibrating plate forming the wall surface of the ink passage and an electrode are disposed in an opposing manner, the vibrating plate is deformed from electrostatic force generated between the vibrating plate and the electrode, and the volume in the ink passage is changed, thereby discharging ink droplets.

A linear scale 128 having slits formed therein is extended between the front side plate 101F and the rear side plate 101R in the main scanning direction of the carriage 23. An encoder sensor 129 including a transmission photosensor for detecting the slits of the linear scale 128 is disposed on the carriage 23. The linear scale 128 and the encoder sensor 129 constitute a linear encoder for detecting movement of the carriage 23.

On one side surface of the carriage 23, a reading sensor (DRESS sensor) 401 is disposed as a reading unit (detection unit) constructed with a reflective photo sensor including a light emitting unit and a light receiving unit so as to detect displacement of landing positions (reading an adjustment pattern) according to the present invention. The pattern reading sensor 401 reads the adjustment pattern for detecting the landing positions formed on a conveying belt 31 as described later. Further, on the other side surface of the carriage 23, a sheet material detecting sensor (tip detecting sensor) 330 is disposed as a sheet material detecting unit so as to detect a tip of a conveyed member.

Further, a maintenance and recovery mechanism (device) 121 for maintaining and recovering a status of a nozzle of the recording heads 24 is disposed on a non-printing field on one side of the scanning direction of the carriage 23. The maintenance and recovery mechanism 121 is a cap member for capping each nozzle surface 24a of the five recording heads 24. The maintenance and recovery mechanism 121 includes one cap 122a for aspiration and for moisture retention, four caps 122b to 122e for moisture retention, a wiper blade 124 for wiping the nozzle surface 24a of the recording heads 24 as a wiping member, and a dummy discharge tray 125 for performing a dummy discharge. In the non-printing field on the other side of the scanning direction of the carriage 23, a dummy discharge tray 126 for performing a dummy discharge is disposed. In the dummy discharge tray 126, openings 127a to 127e are formed.

As shown in FIG. 3, the sub-scanning conveying unit 3 includes the endless conveying belt 31 stretched and installed between a conveying roller 32 as a driving roller and a driven roller 33 as a tension roller, the conveying belt 31 turning a conveying direction of the paper 5 fed from below by substantially 90 degrees and conveying the paper 5 while the paper 5 is facing the image forming unit 2, a charging roller 34 as a charging unit to which a high voltage is applied as an alternating voltage from a high voltage power supply so as to electrify a surface of the conveying belt 31, a guide member 35 for guiding the conveying belt 31 in an area facing the image forming unit 2, pressing runners 36 and 37 rotatably held in a holding member 136 and pressing the paper 5 on the conveying belt 31 at a position facing the image forming unit 2, a guide plate 38 for pressing a top surface of the paper 5 in which an image is formed in the image forming unit 2, and a separation claw 39 for separating the paper 5 in which the image is formed from the conveying belt 31.

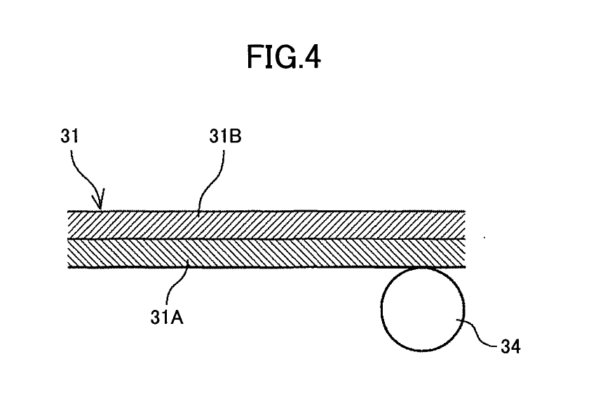

The conveying belt 31 is configured to rotate in a paper conveying direction (sub-scanning direction) by a sub-scanning motor 131 employing a DC brushless motor when the conveying roller 32 is rotated via a timing belt 132 and a timing roller 133. In addition, as shown in FIG. 4, for example, the conveying belt 31 has a double layer structure including a surface layer 31A to be used as a paper attraction surface formed using a pure resin material in which resistance control is not performed such as an ETFE pure material and a rear layer (middle-resistive layer, earth layer) 31B formed using the same material as in the surface layer 31A and resistance control is performed using carbon. However, the structure of the conveying belt 31 is not limited to this and the conveying belt 31 may have a single layer structure or more than double layer structure.

Further, between the driven roller 33 and the charging roller 34, from upstream of a movement direction of the conveying belt 31, there are disposed Mylar (registered trademark, used for removing paper powder) 191 used as a cleaning unit removing paper powder and the like attached to the surface of the conveying belt 31, the Mylar 191 being formed using a PET film as a contact member brought into contact with the surface of the conveying belt 31, a cleaning brush 192 having a brush shape brought into contact with the surface of the conveying belt 31 in the same manner, and an electricity removing brush 193 removing electric charge from the surface of the conveying belt 31.

Further, a cord wheel 137 having a high resolution is installed on a shaft 32a of the conveying roller 32 and an encoder sensor 138 including a transmission type photo sensor for detecting a slit 137a formed on the cord wheel 137 is disposed. The cord wheel 137 and the encoder sensor 138 constitute a rotary encoder.

The paper feed unit 4 is removable from the apparatus body 1 and includes a paper feed cassette 41 as a containing unit loading and holding multiple sheets of paper 5 therein, a paper feed runner 42 and a friction pad 43 separating and feeding the paper 5 in the paper feed cassette 41 one by one, and a pair of register rollers 44 registering the paper 5 to be fed.

The paper feed unit 4 also includes a manual paper feed tray 46 for loading and holding multiple sheets of paper 5 therein, a manual paper feed runner 47 for feeding the paper 5 one by one from the manual paper feed tray 46, and a perpendicular conveying runner 48 for conveying the paper 5 fed from the paper feed cassette or a duplex printing unit optionally installed on a lower portion of the apparatus body 1. The members for sending the paper 5 to the sub-scanning conveying unit 3 such as the paper feed runner 42, register rollers 44, manual paper feed runner 47, and perpendicular conveying runner 48 are rotated by a paper feed motor (driving unit) 49 including an HB stepping motor via an electromagnetic clutch not shown in the drawings.

The paper ejection conveying unit 7 includes tree conveying rollers 71a, 71b, and 71c (referred to as a conveying roller 71 unless a specific element is specified) conveying the paper 5 separated by the separation claw 39 in the separation claw 39, spurs 72a, 72b, and 72c (referred to as a spur 72 in the same manner) facing each of the conveying rollers 71, a pair of reverse rollers 77 and a pair of reverse paper ejection rollers 78 for reversing the paper 5 and sending the paper 5 facedown to the paper ejection tray 8.

As shown in FIG. 1, in order to perform manual single feed, a manual single paper feed tray 141 is disposed on one side of the apparatus body 1 in an openable and closable manner (openable to fall) relative to the apparatus body 1. When the manual single feed is performed, the manual single paper feed tray 141 is opened to fall to a position shown in an imaginary line in FIG. 1. The paper 5 manually fed from the manual single paper feed tray 141 is guided on a top surface of a guide plate 110 and it is possible to linearly insert the paper 5 between the conveying roller 32 and the pressing runner 36 in the sub-scanning conveying unit 3.

On the other hand, in order to eject the paper 5 faceup after image formation, a straight paper ejection tray 181 is disposed on the other side of the apparatus body 1 in an openable and closable manner (openable to fall). When the straight paper ejection tray 181 is opened (opened to fall), it is possible to linearly eject the paper 5 sent from the paper ejection conveying unit 7 to the straight paper ejection tray 181.

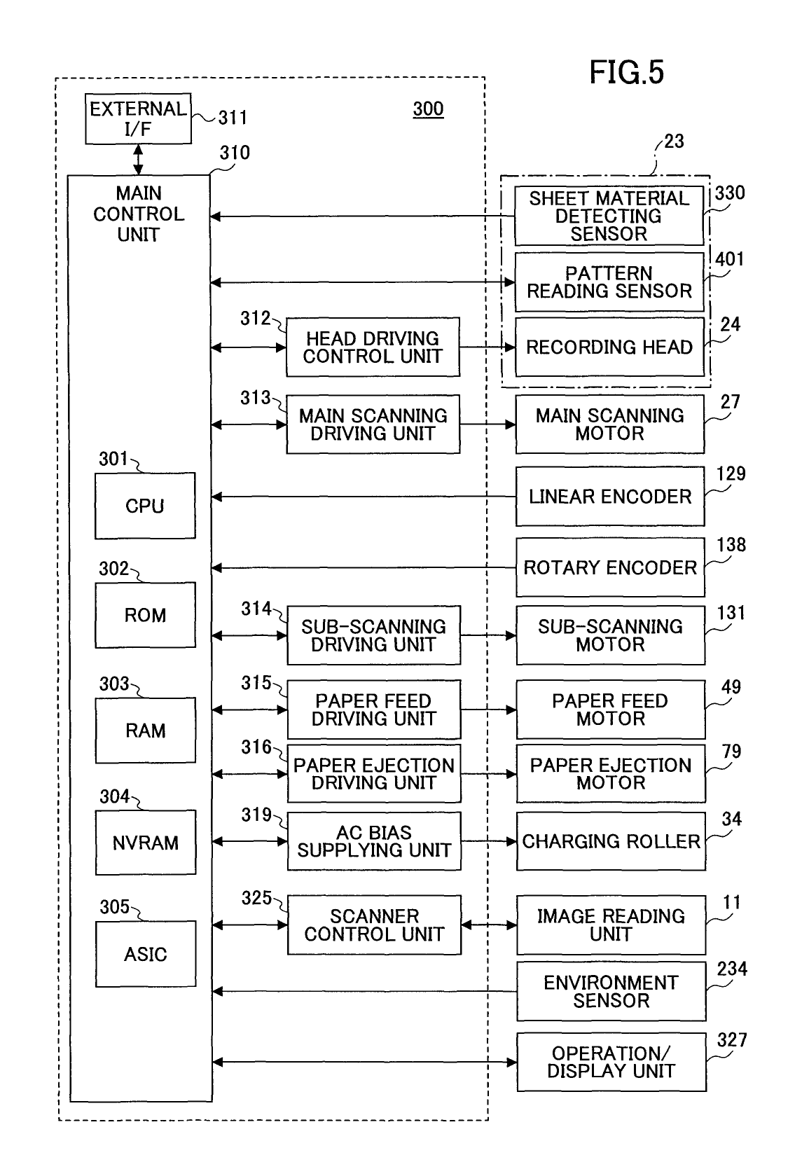

In the following, an outline of a control unit of the image forming apparatus is described with reference to a block diagram of FIG. 5.

A control unit 300 is provided with a main control unit 310 controlling an entire portion of the apparatus and controlling formation of an adjustment pattern, detection of the adjustment pattern, and adjustment (correction) of landing positions according to the present invention. The main control unit 310 includes a CPU 301, a ROM 302 storing a program executed by the CPU 301 and other fixed data, a RAM 303 temporarily storing image data and the like, a nonvolatile memory (NVRAM) 304 holding data even when the apparatus is powered off, and an ASIC 305 processing various types of signals relative to the image data, performing image processing in which sorting and the like is performed, and processing input and output signals for controlling the entire portion of the apparatus.

Moreover, the control unit 300 also includes a external I/F 311 transmitting and receiving data and signals between a host and the main control unit 310, a head driving control unit 312 having a head driver (disposed on the recording heads 24 in practice) constructed using ASIC for converting a head data generation array for controlling driving of the recording heads 24, a main scanning driving unit (motor driver) 313 driving the main scanning motor 27 moving the carriage 23 so as to perform scanning, a sub-scanning driving unit (motor driver) 314 driving the sub-scanning motor 131, a paper feed driving unit 315 driving the paper feed motor 49, a paper ejection driving unit 316 driving a paper ejection motor 79 driving each roller of the paper ejection conveying unit 7, an AC bias supplying unit 319 supplying an AC bias to the charging roller 34, a recovery system driving unit (not shown in the drawings) driving a maintenance and recovery motor driving the maintenance and recovery mechanism 121, a duplex driving unit (not shown in the drawings) driving the duplex printing unit when the duplex printing unit is installed, a solenoid driving unit (driver) (not shown in the drawings) driving various types of solenoids (SOL), a clutch driving unit (not shown in the drawings) driving electromagnetic clutches and the like, and a scanner control unit 325 controlling the image reading unit 11.

Further, various types of detection signals from an environment sensor 234 and the like are input to the main control unit 310, the environment sensor 234 detecting an ambient temperature and an ambient humidity (environmental conditions) in the vicinity of the conveying belt 31. In addition, although detection signals of various types of other sensors not shown in the drawings are also input to the main control unit 310, such detection signals are omitted in the drawings. Further, the main control unit 310 obtains necessary key inputs and outputs display information between various types of keys such as a numeric keypad, a print start key, and the like and an operation/display unit 327 including various types of indicators.

Moreover, output signals from the above-mentioned photosensor (encoder sensor) 129 constituting the linear encoder detecting a position of the carriage are input to the main control unit 310. The main control unit 310 reciprocates the carriage 23 in the main scanning direction by controlling the driving of the main scanning motor 27 via the main scanning driving unit 313 based on the output signals. Further, output signals (pulses) from the above-mentioned photosensor (encoder sensor) 138 constituting the rotary encoder detecting an amount of movement of the conveying belt 31 are input to the main control unit 310. The main control unit 310 moves the conveying belt 31 via the conveying roller 32 by controlling the driving of the sub-scanning motor 131 via the sub-scanning driving unit 314 based on the output signals.

The main control unit 310 performs processing for forming an adjustment pattern on the conveying belt 31, performs light-emission driving control for causing the light emitting unit of the pattern reading sensor 401 to emit light, the pattern reading sensor 401 being installed on the carriage 23, inputs output signals of the light receiving unit to read the adjustment pattern, detects an amount of displacement of landing positions from the reading, and performs control based on the amount of displacement of landing positions such that timing of droplet discharging by the recording heads 24 is corrected so as to eliminate the displacement of landing positions. This processing is described in detail later.

In the following, an image forming operation in the image forming apparatus constructed in this manner is briefly described. An amount of rotation of the conveying roller 32 driving the conveying belt 31 is detected and the driving of the sub-scanning motor 131 is controlled in accordance with the detected amount of rotation. And a high voltage having positive and negative rectangular waves as an alternating voltage is applied to the charging roller 34 from the AC bias supplying unit 319. In accordance with this, positive and negative charges are alternately applied to the conveying belt 31 to form band-like areas in a conveying direction of the conveying belt 31 and the conveying belt 31 is charged with a predetermined charge width, so that a non-uniform electric field is generated.

When the paper 5 is fed from the paper feed unit 4, sent between the conveying roller 32 and the first pressing runner 36, and sent to the conveying belt 31 in which the non-uniform electric field is generated due to the formation of positive and negative charges, the paper 5 is instantaneously polarized in accordance with a direction of an electric field. The paper 5 is attracted to the conveying belt 31 with an electrostatic adsorption force and conveyed in accordance with movement of the conveying belt 31.

Then, the paper 5 is intermittently conveyed on the conveying belt 31 and an image is recorded (printed) by discharging droplets of recording liquid onto the stationary paper 5 from the recording heads 24 while moving the carriage 23 in the main scanning direction. A tip of the paper 5 in which the printing is performed is separated from the conveying belt 31 using the separation claw 39. The separated paper 5 is sent to the paper ejection conveying unit 7 and ejected on the paper ejection tray 8.

While waiting for printing (recording), the carriage 23 is moved to the maintenance and recovery mechanism 121, where the nozzle surface of the recording head 24 is capped with the cap 122 and discharge failure resulting from dried ink is prevented by maintaining the nozzle in a wet state. Further, while the recording head 24 is capped with the cap 122a for aspiration and for moisture retention, the recording liquid is aspirated from the nozzle, a recovery operation is performed so as to discharge the thickened recording liquid and air bubbles, and wiping is performed using the wiper blade 124 so as to remove the ink attached to the nozzle surface of the recording heads 24 in the recovery operation. In addition, a dummy discharge operation is performed before recording, during recording, and the like so as to discharge ink irrelevant to the recording to the dummy discharge tray 125. In accordance with this, a stable discharging performance of the recording heads 24 is maintained.

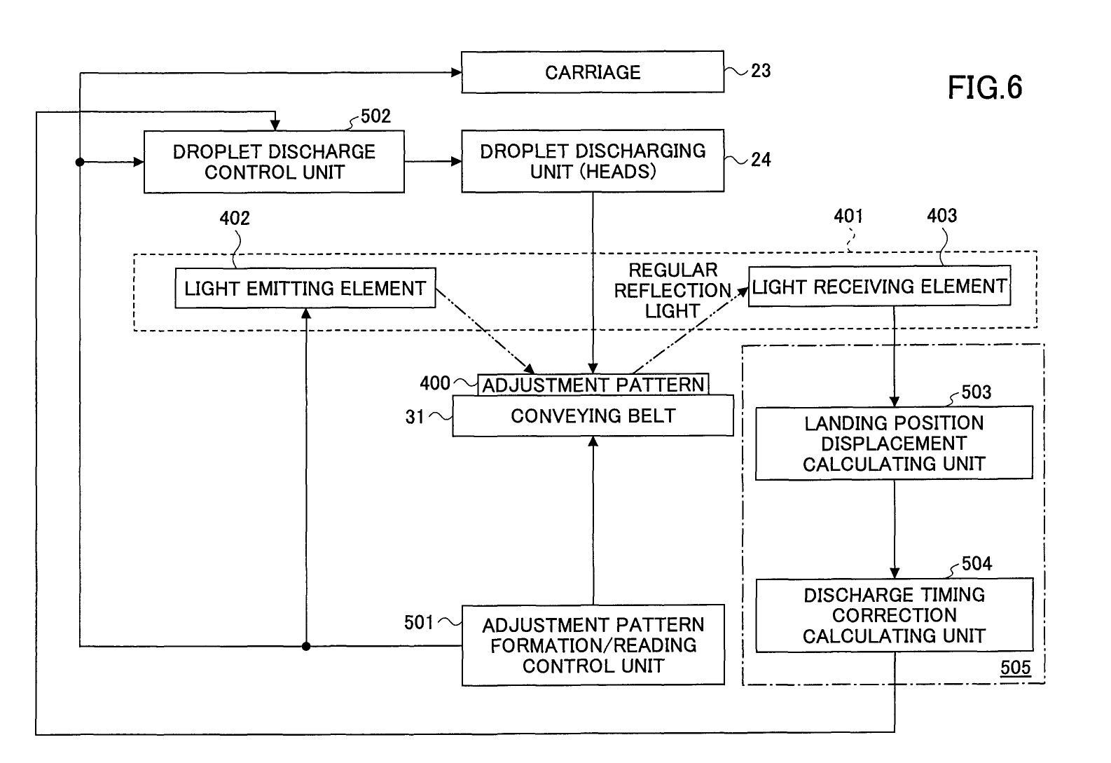

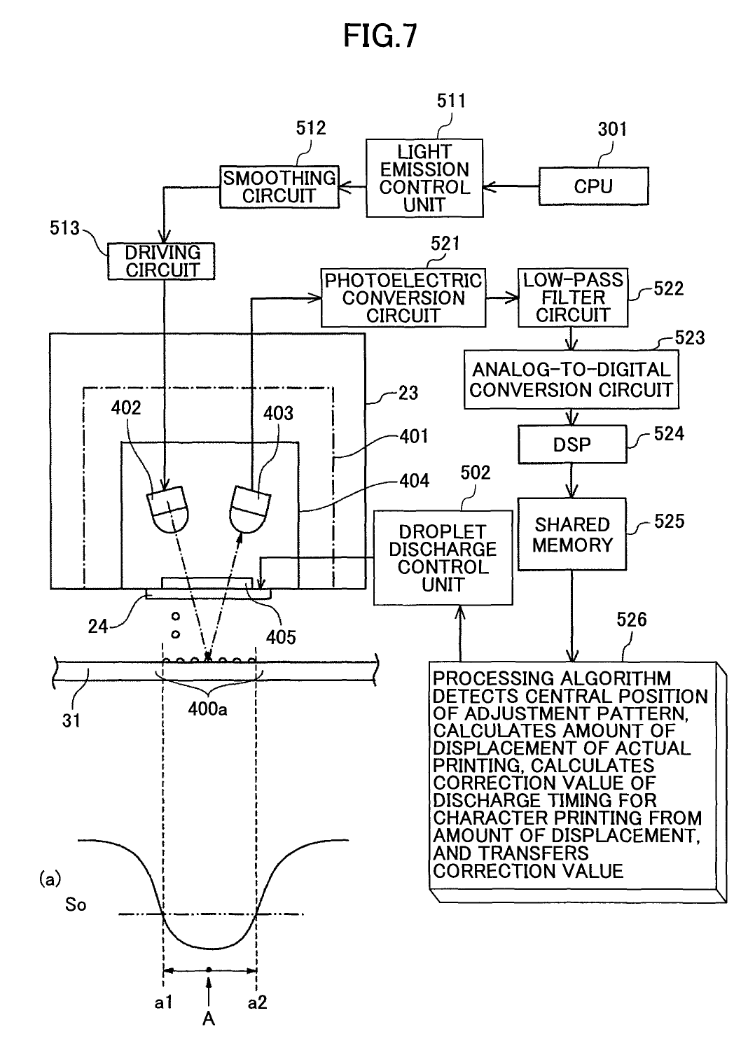

In the following, elements relating to control for correcting displacement of landing positions of droplets in the image forming apparatus are described with reference to FIGS. 6 and 7. FIG. 6 is a block diagram illustrating functions of a correction unit correcting displacement of landing positions of droplets. FIG. 7 is a block diagram schematically illustrating a functional flow of a correction operation for correcting displacement of landing positions of droplets.

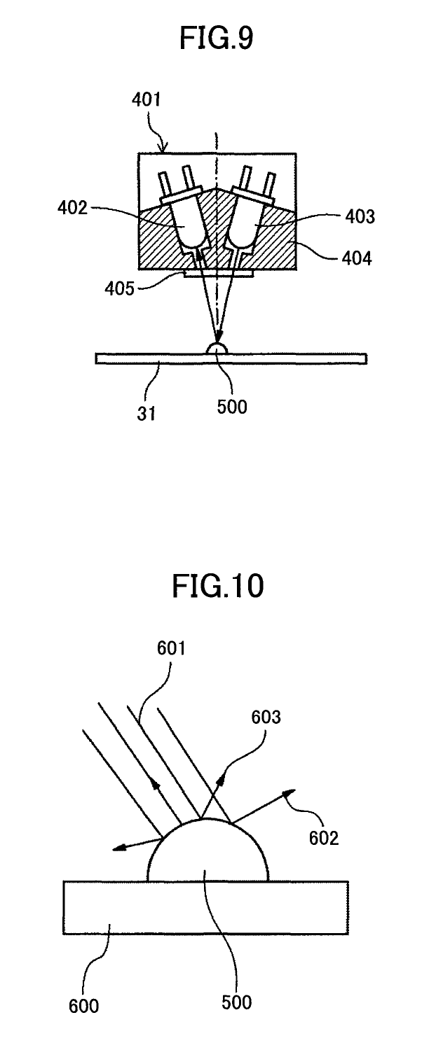

As shown in FIGS. 7 and 9, the carriage 23 is provided with the pattern reading sensor 401 detecting an adjustment pattern (DRESS pattern, test pattern, detection pattern) 400 formed on the conveying belt 31 which is a water-repellent member. The pattern reading sensor 401 includes a light emitting element 402 as a light emitting unit emitting light to the adjustment pattern 400 on the conveying belt 31 arranged in a direction orthogonal relative to the main scanning direction, a light receiving element 403 as a light receiving unit receiving a regular reflection light from the adjustment pattern 400, and a holder 404 holding the light emitting element 402 and the light receiving element 403 therein as a package. A lens 405 is disposed on a light projection portion and a light receiving portion of the holder 404.

As shown in FIG. 2, the light emitting element 402 and the light receiving element 403 in the pattern reading sensor 401 are arranged in a direction orthogonal relative to the scanning direction of the carriage 23. In accordance with this, it is possible to reduce an influence on a detection result from a change of a movement speed of the carriage 23. Further, the light emitting element 402 may employ a relatively simple and inexpensive light source emitting light of the infrared region, visible light, or the like such as an LED. Further, a detection range of a spot diameter (detection range, detection field) of the light source is of mm order so as to use an inexpensive lens instead of using a high precision lens.

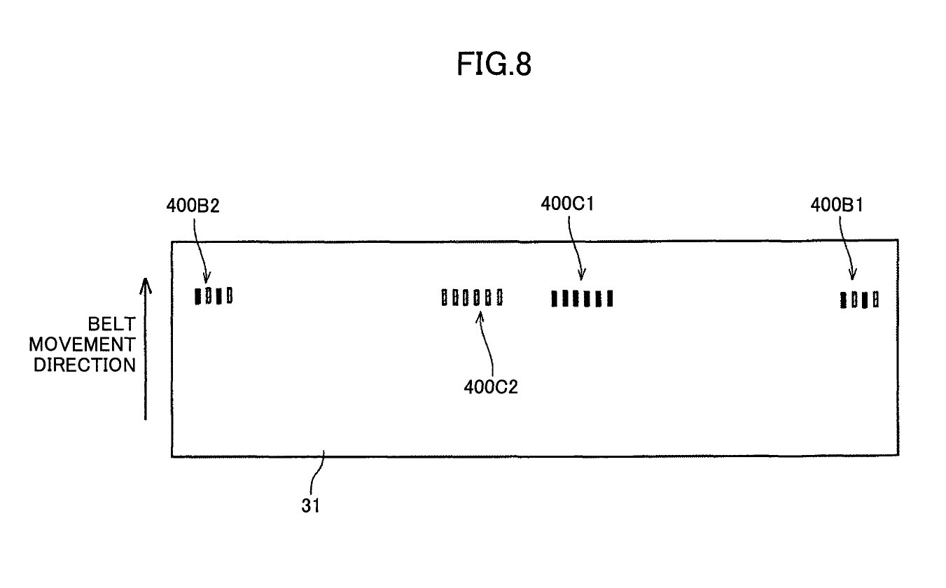

When correction of displacement of landing positions is instructed, an adjustment pattern formation/reading control unit 501 reciprocates the carriage 23 so as to perform scanning in the main scanning direction on the conveying belt 31 and discharges droplets from the recording heads 24 which are a droplet discharging unit via a droplet discharge control unit 502, thereby forming the adjustment pattern 400 (400B1, 400B2, 400C1, 400C2, and the like) having a line-like shape as shown in FIG. 8 and constructed with plural independent droplets 500. In addition, the adjustment pattern formation/reading control unit 501 includes the CPU 301 of the main control unit 310 and the like.

Moreover, the adjustment pattern formation/reading control unit 501 controls reading of the adjustment pattern 400 formed on the conveying belt 31 using the pattern reading sensor 401. The adjustment pattern reading control is performed by driving the light emitting element 402 of the pattern reading sensor 401 while moving the carriage 23 in the main scanning direction. Specifically, as shown in FIG. 7, the CPU 301 of the main control unit 310 sets a PWN value for driving the light emitting element 402 of the pattern reading sensor 401 in a light emission control unit 511, an output of the light emission control unit 511 is smoothed in a smoothing circuit 512 and provided to a driving circuit 513. In accordance with this, the driving circuit 513 drives and causes the light emitting element 402 to emit a light to the adjustment pattern 400 on the conveying belt 31.

In the pattern reading sensor 401, when the light is emitted to the adjustment pattern 400 on the conveying belt 31 from the light emitting element 402, a regular reflection light reflected from the adjustment pattern 400 is projected onto the light receiving element 403. A detection signal is output from the light receiving element 403 in accordance with an amount of the regular reflection light from the adjustment pattern 400 and the detection signal is input to a landing position displacement calculating unit 503 of a landing position correcting unit 505. Specifically, as shown in FIG. 7, the output signal from the light receiving element 403 of the pattern reading sensor 401 is subjected to photoelectric conversion in a photoelectric conversion circuit 521 (omitted in FIG. 5) included in the main control unit 310. A signal obtained in the photoelectric conversion (sensor output voltage) is input to a low-pass filter circuit 522 so as to remove a noise. Then, the signal from which the noise is removed is analog-to-digital converted in an analog-to-digital conversion circuit 523. The analog-to-digital converted sensor output voltage data is stored in a shared memory 525 using a signal processing circuit (DSP) 524.

The landing position displacement calculating unit 503 of the landing position correcting unit 505 detects a position of the adjustment pattern 400 based on the output result of the light receiving element 403 of the pattern reading sensor 401 and calculates an amount of displacement (amount of displacement of droplet landing positions) relative to a reference position. The amount of displacement of landing positions calculated in the landing position displacement calculating unit 503 is provided to a discharge timing correction calculating unit 504. The discharge timing correction calculating unit 504 calculates an amount of correction of discharge timing when the droplet discharge control unit 502 drives the recording heads 24 such that the displacement of landing positions is eliminated and the discharge timing correction calculating unit 504 sets the calculated amount of correction of discharge timing in the droplet discharge control unit 502. In accordance with this, the droplet discharge control unit 502 corrects the discharge timing based on the amount of correction and drives the recording heads 24, so that the displacement of droplet landing positions is reduced.

Specifically, as shown in FIG. 7, a processing algorithm 526 executed by the CPU 301 detects a central position (point A) of each adjustment pattern 400 (single line pattern is referred to as “400a”) from the sensor output voltage So stored in the shared memory 525 and shown in FIG. 7-(a), for example. The processing algorithm 526 calculates an actual amount of displacement of landing positions from a relevant head relative to the reference position (reference head), calculates the amount of correction of discharge timing for character printing from the calculated amount of displacement, and sets the amount of correction in the droplet discharge control unit 502.

In the following, the adjustment pattern 400 according to the present invention is described with reference to drawings from FIG. 10.

First, principles of the detection of landing positions (detection of patterns) according to the present invention are described. The following describes how a light from a droplet is diffused when the light is projected onto the droplet (hereafter referred to as an “ink droplet”) with reference to FIG. 10.

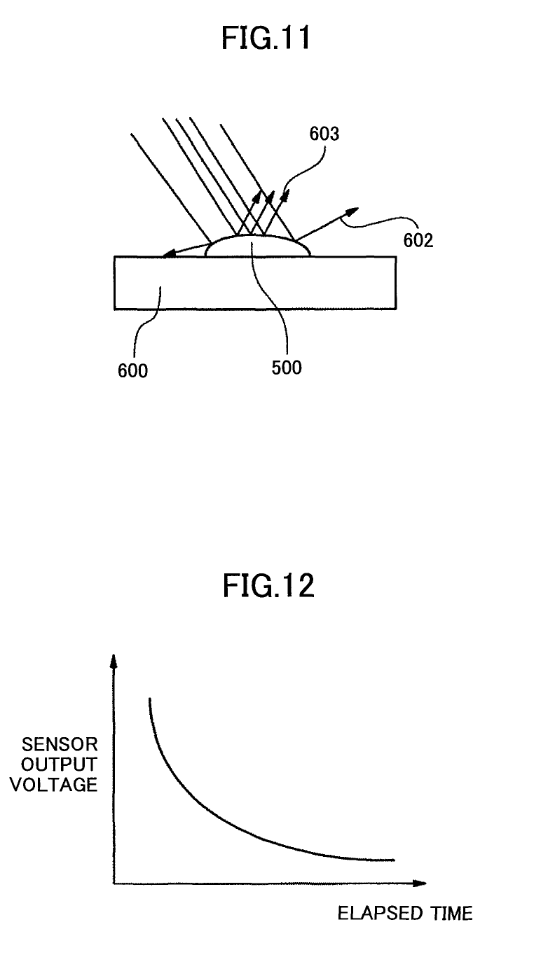

As shown in FIG. 10, when an incident light 601 is projected onto the ink droplet 500 (ink droplet has a hemispheric shape when landed) landed on a landed member 600, the ink droplet 500 has a rounded glossy surface, so that a large amount of the incident light 601 becomes a diffuse reflection light 602 and a small amount of light is detected as a regular reflection light 603. However, as shown in FIG. 11, the ink droplet 500 dries with passage of time, so that gloss is lost on the surface. Further, the ink droplet 500 gradually becomes flat from the hemispheric shape, so that a range and a percentage of the generate regular reflection light 603 is relatively increased in comparison with the diffuse reflection light 602. Accordingly, when the regular reflection light 603 is received in the light receiving element 403, as shown in FIG. 12, the sensor output voltage is reduced with the passage of time and detection accuracy is reduced with the passage of time.

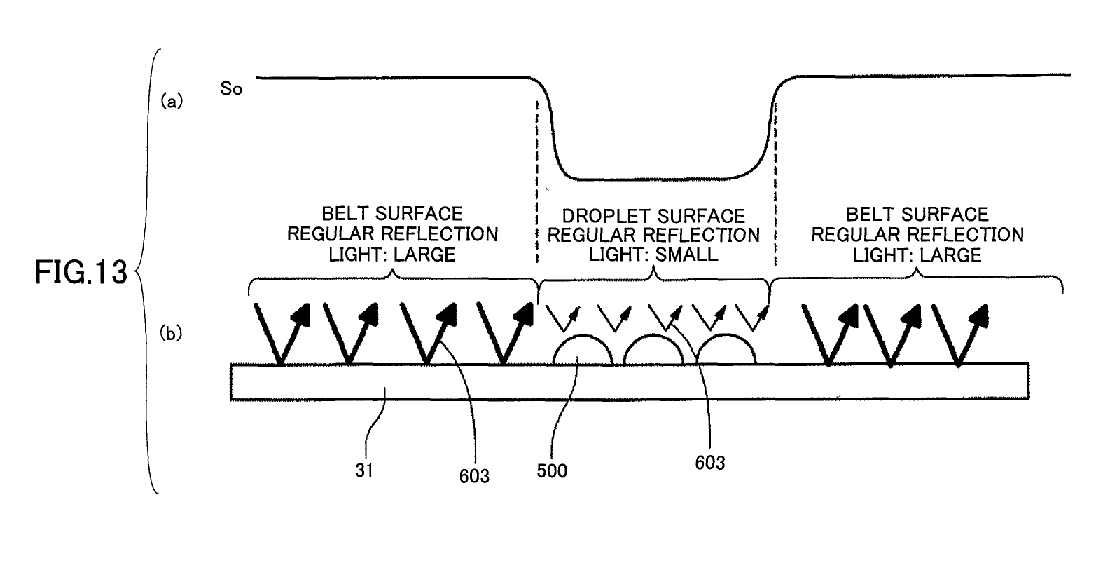

Next, detection of a position of the ink droplet 500 constituting the adjustment pattern 400 (constituting the single pattern 400a in practice) is described with reference to FIG. 13.

The surface of the conveying belt 31 (belt surface) has gloss and a regular reflection light is likely to be returned when a light from the light emitting element 402 is projected thereon. Accordingly, in FIG. 13-(b), in one area of the conveying belt 31 where the ink droplet 500 is not landed, the incident light 601 from the light emitting element 402 is substantially reflected on the belt surface as the regular reflection light 603, so that an amount of the regular reflection light 603 is large. In accordance with this, as shown in FIG. 13-(a), the output (sensor output voltage) of the light receiving element 403 receiving the regular reflection light 603 is relatively large.

On the other hand, in the FIG. 13-(b), in the other area of the conveying belt 31 where the ink droplets 500 are landed densely and independently from one another, the light is diffused on the surface of the ink droplet 500 having gloss and the hemispheric shape, so that the amount of the regular reflection light 603 is reduced. Accordingly, as shown in FIG. 13-(a), the output (sensor output voltage) of the light receiving element 403 receiving the regular reflection light 603 is relatively small. In addition, the word “densely” refers to a status where an area among the ink droplets 500 in a predetermined detection field is smaller than an area of a field (attachment area) on which the ink droplets 500 are landed.

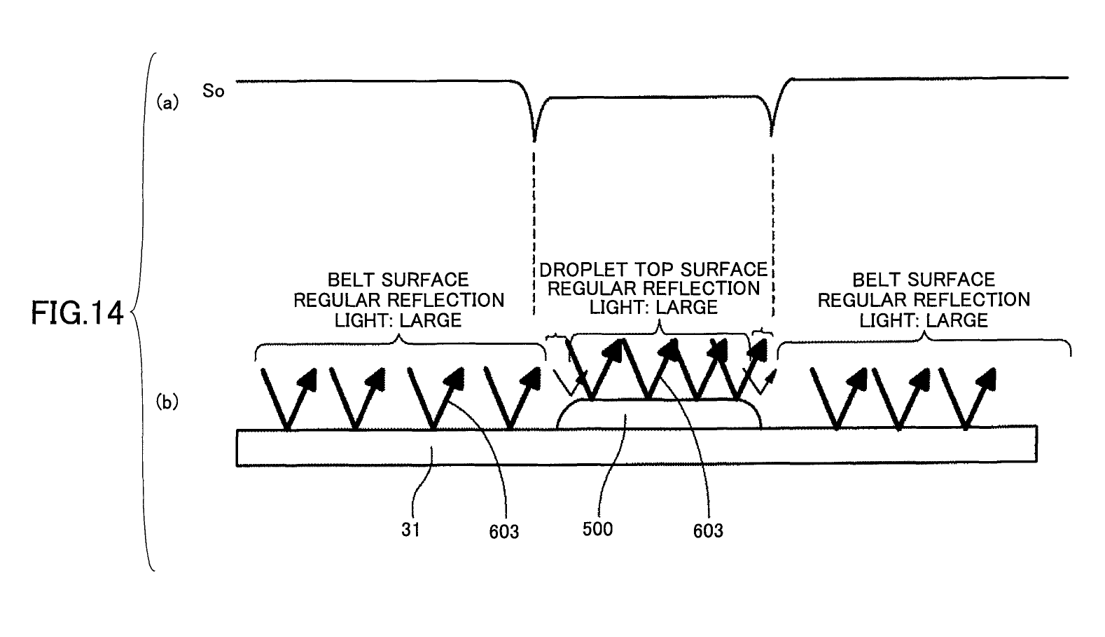

By contrast, as shown in FIG. 14-(b), when the ink droplets are brought into contact with one another and are connected on the conveying belt 31, top surfaces of the connected ink droplets 500 become flat. Accordingly, the regular reflection light 603 is increased and the sensor output voltage has substantially the same output value as on the surface of the conveying belt 31 as shown in FIG. 14-(a), so that it is difficult to detect positions of the ink droplets 500. Even when the ink droplets are united, an edge portion of the connected ink droplets generates a scattered light. However, a range of the edge portion is extremely limited, so that detection thereof is difficult. If such a scattered light is to be detected, an area observed by the light receiving element 403 (detection field) must be narrow. This may be influenced by a noise factor such as a small flaw, dust, or the like on the surface of the conveying belt 31, so that detection accuracy or reliability of a detection result is reduced.

Accordingly, by determining a portion with reduced regular reflection light in the output from the light receiving unit receiving the regular reflection light from the ink droplets, it is possible to detect landing positions of ink droplets. In order to detect the landing positions of ink droplets with high accuracy, the adjustment pattern 400 must include plural independent droplets within the detection field of the pattern reading sensor 401 and be densely arranged (the area among the ink droplets is smaller than the attachment area of droplets). When this adjustment pattern is formed, it is possible to detect the landing positions of droplets (adjustment pattern) with a simple structure of the light emitting unit and the light receiving unit.

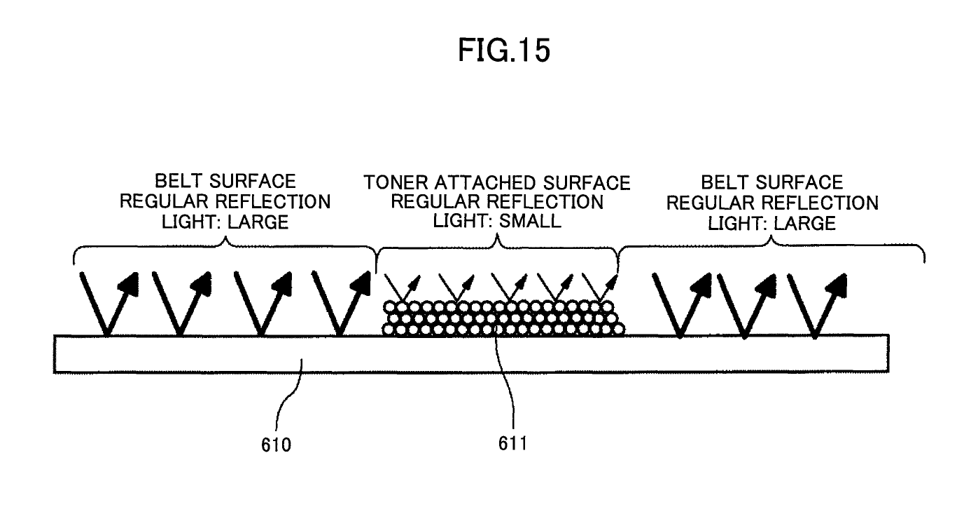

In the following, a difference between toner in an electrophotographic type and droplets in a liquid discharging type is described with reference to FIG. 15.

A form of the toner in the electrophotographic type is maintained when the toner is attached on an attached member, so that when a toner 611 constituting the adjustment pattern is formed on an attached member 610 in an overlapping manner as shown in FIG. 15, an amount of regular reflection light on a toner-attached surface is reduced (smaller) in comparison with an amount of regular reflection light on other area of the attached member 610 where the toner 611 is not attached. Thus, it is possible to detect the adjustment pattern from an output of the light receiving unit receiving the regular reflection light.

By contrast, when the droplets in the liquid discharging type are landed and connected to adjacent droplets on the landed member, top surfaces of the connected droplets become a flat surface, so that the droplets have properties of generating substantially the same regular reflection light as in other area of the landed member where the droplets are not landed. Thus, even when a structure for merely detecting the adjustment pattern in accordance with a change of the amount of regular reflection light from the adjustment pattern is employed without considering these properties of the droplets, detection accuracy is significantly reduced. Even when ink droplets are landed on a medium which allows permeation of the ink droplets such as a recorded medium and the adjustment pattern is formed on the medium, it is impossible to accurately detect the adjustment pattern.

In view of these properties of droplets, in the present invention, an adjustment pattern including independent plural droplets is formed on a water-repellent conveying belt which is a member on which the adjustment pattern is formed, the adjustment pattern having the area among the droplets smaller than the attachment area of the droplets in the detection field. Accordingly, it is possible to accurately detect the adjustment pattern in accordance with a change of the amount of regular reflection light from the adjustment pattern and adjust (correct) displacement of landing positions of droplets with high accuracy.

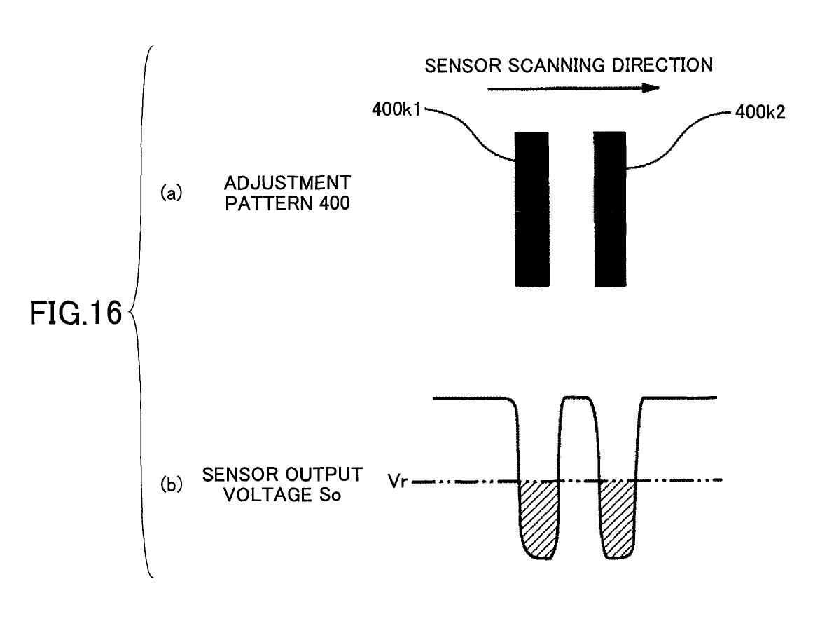

In the following, another example of processing for detecting (processing for reading) a position of the adjustment pattern 400 formed on the conveying belt 31 is described with reference to FIGS. 16 to 18.

In a first example shown in FIG. 16, a line-shaped pattern 400k1 is formed using the recording head 24k1 and a line-shaped pattern 400k2 is formed using the recording head 24k2, for example, on the conveying belt 31 as shown in FIG. 16-(a). When the pattern reading sensor 401 scans these line-shaped patterns in a sensor scanning direction (carriage main scanning direction), the light receiving element 403 of the pattern reading sensor 401 outputs a result. From the output result, the sensor output voltage So falling at the pattern 400k1 and the pattern 400k2 is obtained as shown in FIG. 16-(b).

When the sensor output voltage So is compared with a predetermined threshold Vr, it is possible to detect positions of the sensor output voltage So falling below the threshold Vr as edges of the patterns 400k1 and 400k2. In this case, by calculating a center of gravity of an area of a field (shown by shaded portions in FIG. 16-(b)) enclosed by the threshold Vr and the sensor output voltage So, it is possible to use the center of gravity as a center of the patterns 400k1 and 400k2. Accordingly, by using the center obtained in this manner, it is possible to reduce a margin of error resulting from minute fluctuation of the sensor output voltage.

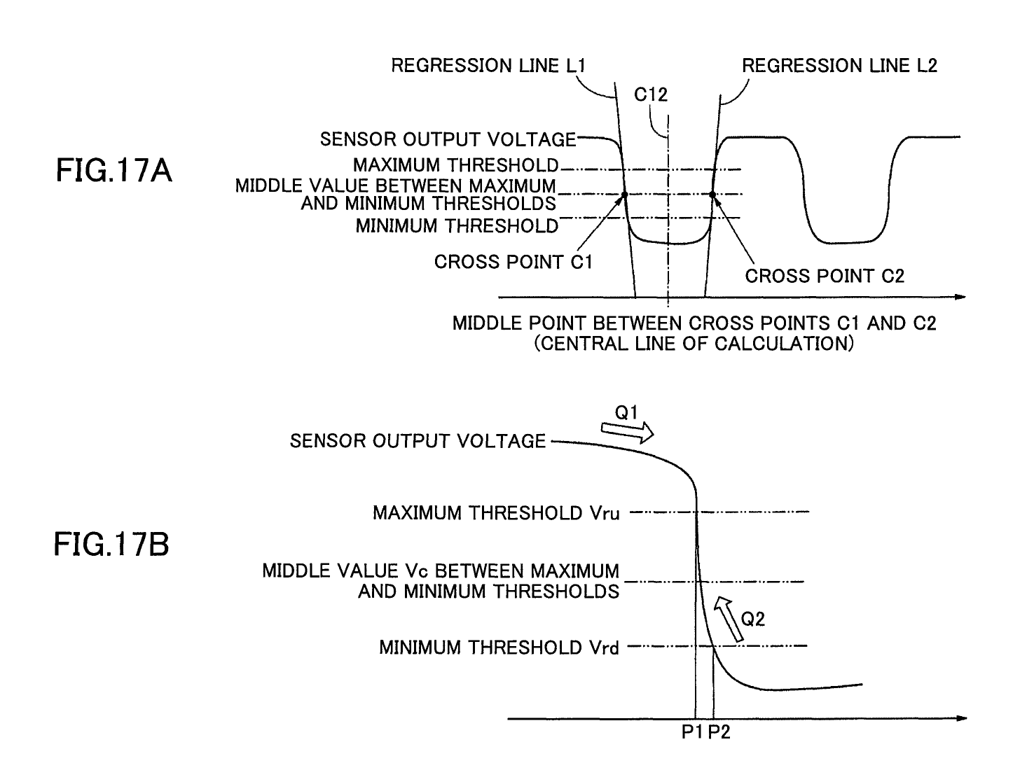

In a second example shown in FIGS. 17A and 17B, by scanning the same patterns 400k1 and 400k2 as in the first example using the pattern reading sensor 401, a sensor output voltage So shown in FIG. 17A is obtained. FIG. 17B shows an enlarged view indicating a falling portion of the sensor output voltage So.

The falling portion of the sensor output voltage So is searched in a direction indicated by an arrow Q1 in FIG. 17B and a point where the sensor output voltage So is below (less than) a minimum threshold Vrd is stored as a point P2. Then, the sensor output voltage So is searched in a direction indicated by an arrow Q2 in FIG. 17B and a point where the sensor output voltage So exceeds a maximum threshold Vru is stored as a point P1. A regression line L1 is calculated from the sensor output voltage So between the point P1 and the point P2 and a cross point between the regression line L1 and a middle value Vc between the maximum and minimum thresholds is calculated as a cross point C1 using an obtained regression line formula. In the same manner, a regression line L2 is calculated in a rising portion of the sensor output voltage So and a cross point between the regression line L2 and the middle value Vc between the maximum and minimum thresholds is calculated as a cross point C2. A central line C12 is obtained by (the cross point C1+the cross point C2)/2 from a middle point between the cross point C1 and the cross point C2.

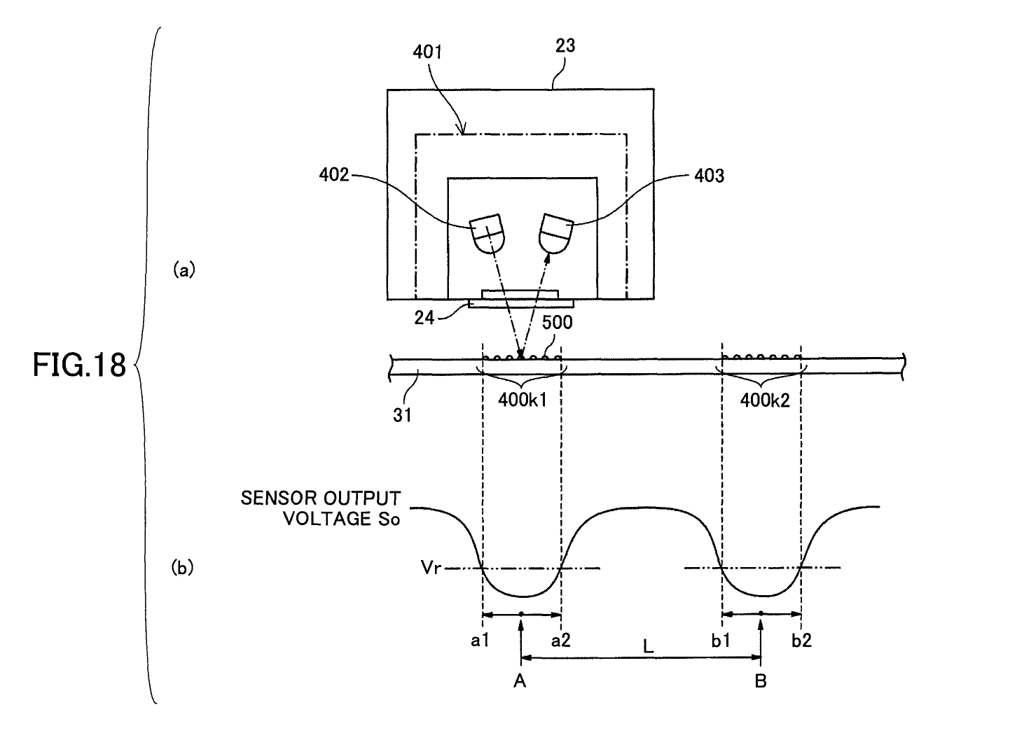

In a third example shown in FIG. 18, in the same manner as in the first example, the line-shaped pattern 400k1 is formed using the recording head 24k1 and the line-shaped pattern 400k2 is formed using the recording head 24k2, for example, on the conveying belt 31 as shown in FIG. 18-(a). When the pattern reading sensor 401 scans these line-shaped patterns in the main scanning direction, a sensor output voltage (voltage output from photoelectric conversion) So as shown in FIG. 18-(b) is obtained.

In this case, above-mentioned the processing algorithm 526 performs processing for removing a high-frequency noise using an IIR filter, evaluates quality of a detection signal (presence and absence of lack, instability, excess), detects a tilted portion in the vicinity of the threshold Vr, and calculates a regression line. Then, the processing algorithm 526 calculates cross points a1, a2, b1, and b2 (a position counter including ASIC: application-specific integrated circuit performs calculation in practice), calculates a middle point A between the cross points a1 and a2 and a middle point B between the cross points b1 and b2, and calculates a distance L between the middle point A and the middle point B. In accordance with this, a middle position between the patterns 400k1 and 400k2 is detected.

A difference between an ideal distance between the recording head 24k1 and the recording head 24k2 and the calculated distance L is calculated from (the ideal distance—L). This difference is an amount of displacement in actual printing. The obtained amount of displacement is used to calculate a correction value for correcting timing (liquid discharge timing) of discharging droplets from the recording heads 24k1 and 24k2 and the correction value is set in the droplet discharge control unit 502. In accordance with this, the droplet discharge control unit 502 drives the head using the corrected liquid discharge timing, so that positional displacement is reduced.

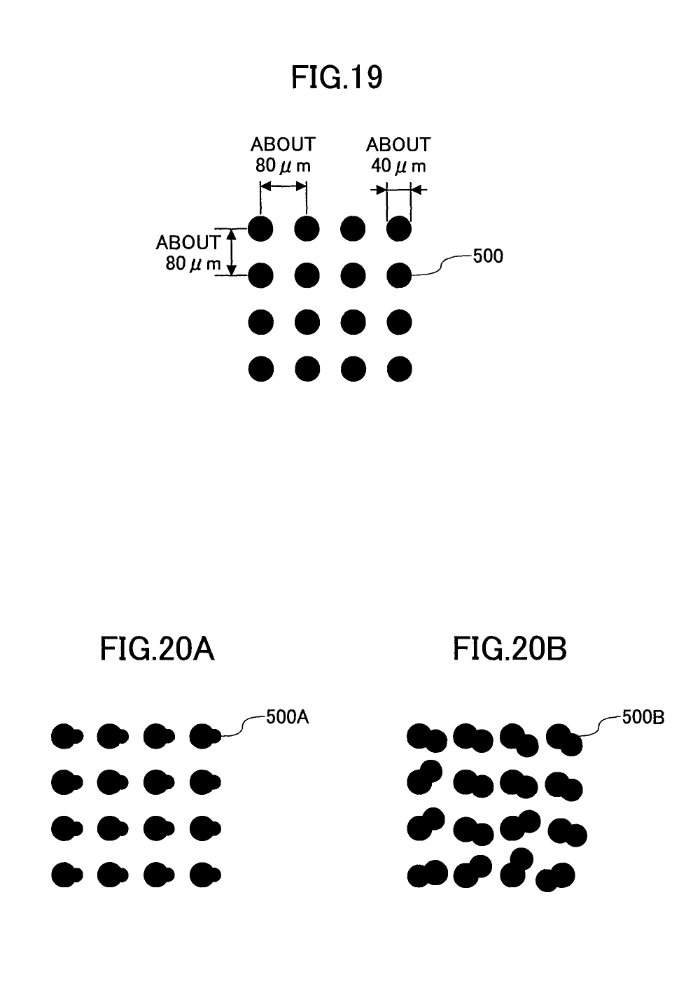

In the following, examples where landed ink droplets forming the adjustment pattern 400 have different shapes are described with reference to FIGS. 19 to 21.

In a first example, FIG. 19 shows an example where plural ink droplets 500 are arranged independently of one another in a grid-like manner.

In a second example, FIG. 20A shows an example where a large droplet (a main droplet, for example) and a small droplet (a satellite droplet or a small droplet, for example) are combined to form one gourd-shaped droplet 500A and plural droplets 500A are arranged independently of one another. FIG. 20B shows an example where two droplets having substantially the same size are combined to form one droplet 500B and plural droplets 500B are arranged independently of one another.

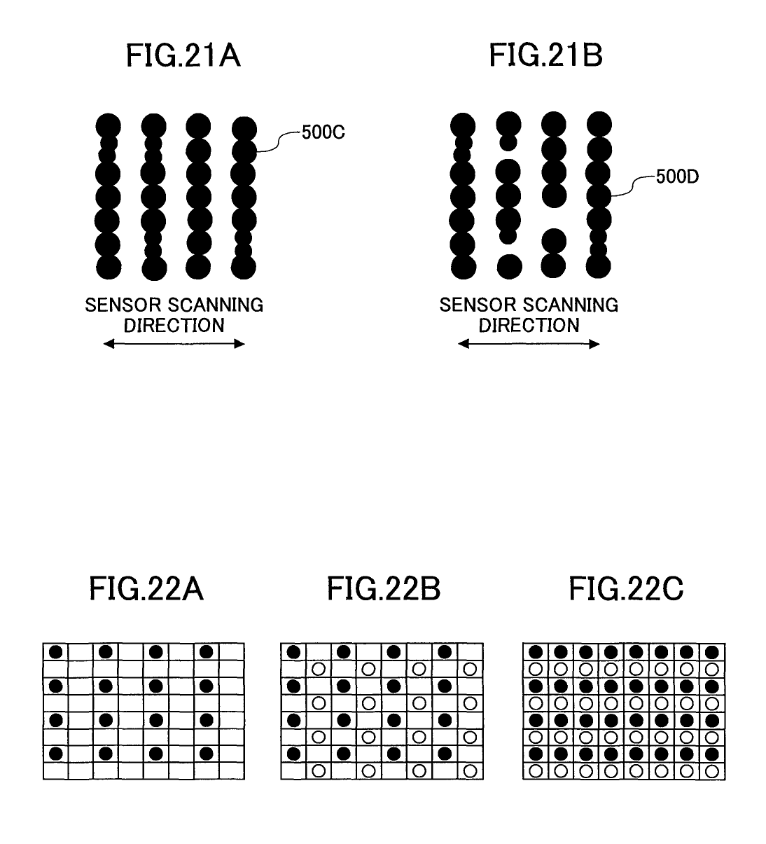

In a third example, FIG. 21A shows an example where droplets are successively combined in a line in a direction orthogonal relative to the scanning direction of the pattern reading sensor 401 to form one droplet 500C and plural droplets 500C in lines are arranged in the sensor scanning direction. FIG. 21B shows an example where one droplet 500D is constituted by a line segment in which a portion of the line in FIG. 21A is broken (a length may be the same or different) and plural droplets 500D in lines are arranged in the sensor scanning direction.

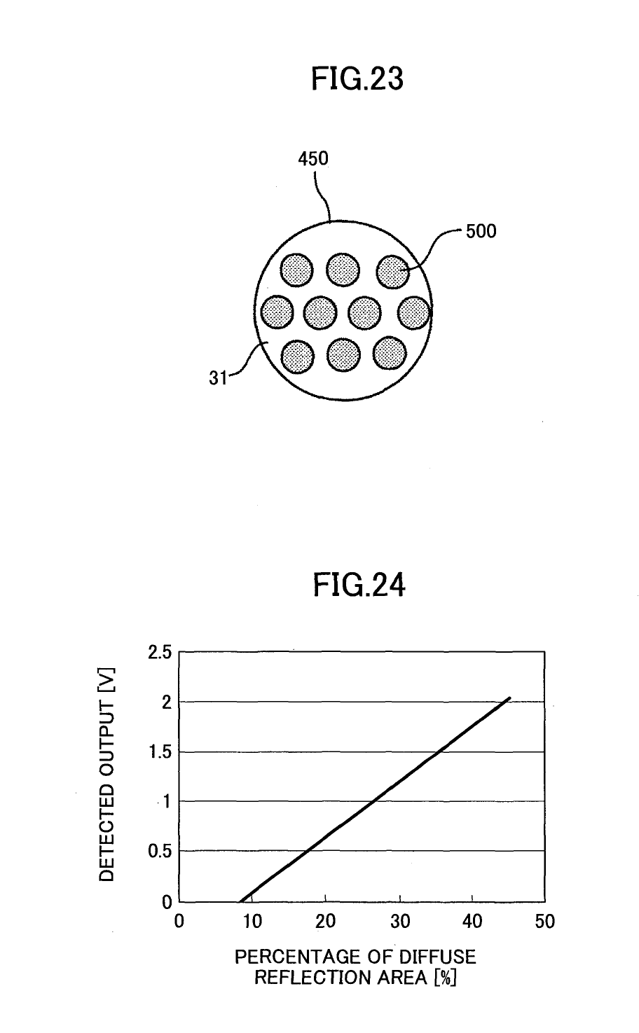

In the following, a structure for improving accuracy of detecting landing positions is described with reference to FIGS. 22A, 22B, 22C, and 23.

First, it is assumed that a percentage of a diffuse reflection light in a reflected light from the adjustment pattern 400 is constant. In other words, as shown in the landed ink droplets at a central portion in FIG. 13, the ink droplets 500 are landed such that scattering in the reflection light from the adjustment pattern 400 is uniform. In accordance with this, it is possible to obtain a high reproducibility of the sensor output voltage (detection potential) provided to the processing algorithm, detect the adjustment pattern 400 (landing positions of droplets) with high accuracy, and adjust displacement of the landing positions of droplets with high accuracy.

In order to have uniform scattering in the reflection light from the adjustment pattern 400, on the surface of the ink droplet, an area of a portion of the surface which generates a diffuse reflection light is set to be constant. For example, as shown in FIG. 22A, plural ink droplets 500 constituting the adjustment pattern 400 are arranged independently in every second dot. In this case, adjacent ink droplets are attached to the conveying belt 31 regularly without being connected to one another and the area of the surface which generates a diffuse reflection light becomes constant. As long as adjacent droplets are arranged independently without being connected to one another, the arrangement may have a structure as shown in FIG. 22B where ink droplets 500 are arranged in a staggered manner or may have a structure as shown in FIG. 22C where the ink droplets 500 are arranged in all dots.

Further, as shown in FIG. 12, the ink droplets become dry with passage of time after the droplets are landed, so that by making a period of time from the landing of the droplets to reception of a regular reflection light by the pattern reading sensor 401 constant, it is possible to secure the reproducibility of the sensor output voltage.

Further, as long as scattering in the reflection light is uniform, each ink droplet 500 may be formed by combining two droplets (the main droplet and the satellite droplet, for example) and plural ink droplets 500 may be regularly arranged as shown in FIGS. 20A and 20B.

Further, in order to have uniform scattering in the reflection light from the adjustment pattern 400, as shown in FIG. 23, a contact area between the ink droplet 500 and the conveying belt 31 in a detection range (detection field) 450 is set to be constant. For example, the plural ink droplets 500 constituting the adjustment pattern 400 are arranged independently of one another in every second dot. Each of the ink droplets 500 is independent of one another and an each discharge amount of the ink droplets 500 is set to be the same, so that the contact area of the ink droplets 500 attached to the conveying belt 31 is constant. In this case, as long as adjacent ink droplets are independent without being connected to one another, ink droplets 500 may be arranged in a staggered manner. Specifically, the contact area is likely to be maintained to be constant when the conveying belt 31 made of fluorine resin (ETFE) having water repellency to pigment ink and relevant pigment ink are used in combination.

Further, the area of the surface of the ink droplet which generates a diffuse reflection light is set to be constant and the contact area between the ink droplet and the belt is constant, so that it is possible to obtain a detection potential having a high reproducibility.

Further, when the ink droplets are not arranged with certain density, detection output to detect presence or absence of the adjustment pattern 400 is not sufficient. In an experiment, a correlation between the area of the ink droplet which generates a diffuse reflection light and the detection output is confirmed to be a relationship as indicated by an approximate line in FIG. 24 and when the area which generates a diffuse reflection light is not less than 10% of an area of the adjustment pattern 400, a required detection output is obtained.

In the following, droplets forming adjustment pattern 400 are described in terms of diffuse reflectance of the pattern.

The diffuse reflectance of the pattern refers to a rate of a portion generating diffuse reflection (a diffused light) within the detection range (detection field) by the pattern reading sensor 401 as shown in FIG. 23. In other words, the diffuse reflectance of the pattern is a value expressed as: the diffuse reflectance of the pattern=a total area of the portion generating diffuse reflection/an area of the detection range.

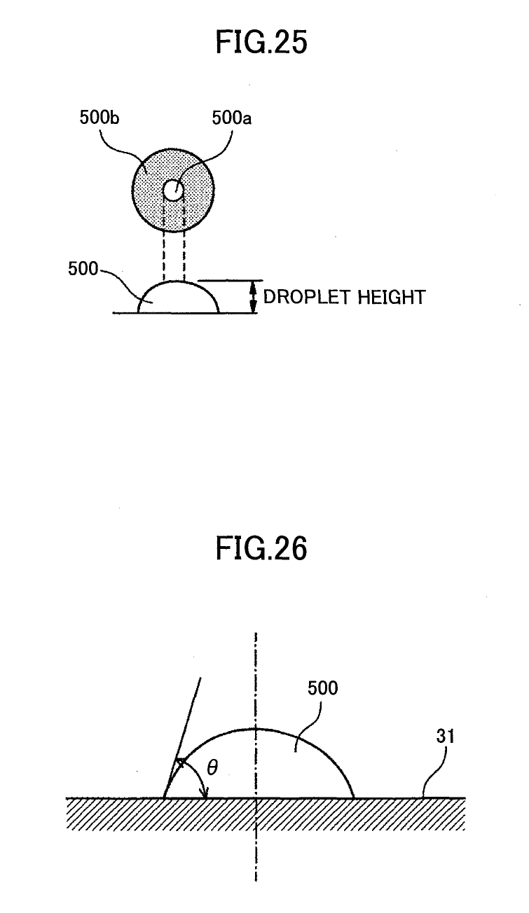

In this case, when the detection range is constant, it is possible to increase the diffuse reflectance of the pattern by enlarging the area of the portion generating diffuse reflection. As shown in FIG. 25, when the ink droplet 500 is attached to the conveying belt 31, the portion generating diffuse reflection has a hemispheric shape in a case of poor wettability (a contact angle θ in FIG. 26 is large). In this case, a circumferential surface of the ink droplet 500 has a portion 500a generating regular reflection and a portion 500b generating diffuse reflection. Accordingly, it is possible to control discharging of the ink droplets such that the portion 500b generating diffuse reflection (a diffuse reflectance of a droplet) is increased in each of the ink droplets 500.

In this case, the diffuse reflectance of a droplet refers to a rate of the portion generating diffuse reflection relative to the contact area with the belt surface and is a value expressed as: the diffuse reflectance of a droplet=the area of the portion generating diffuse reflection in one droplet/the contact area with the belt surface.

Specifically, the droplets used for forming the ink droplet 500 are preferably those droplets having a maximum discharge amount (droplet volume) among droplets used for image formation. In other words, the adjustment pattern 400 is formed by discharging droplets in a print mode by which a maximum droplet is discharged. In accordance with this, a height of the ink droplet 500 shown in FIG. 25 is increased and the diffuse reflectance of a droplet is increased.

Further, an ink composition is different in each color (cyan, magenta, yellow, and black) and shapes of the ink droplets 500 may be different in each color. By discharging droplets with a discharge amount (droplet volume) in accordance with colors of the droplets, it is possible to increase the diffuse reflectance of a droplet.

In this manner, when providing the droplet discharging unit (the recording head) discharging droplets, the unit forming the adjustment pattern for detecting landing positions of the droplets on the water-repellent member receiving the droplets, the adjustment pattern being constituted using plural independent droplets, the reading unit having the light emitting unit projecting a light onto the adjustment pattern, the light receiving unit receiving a regular reflection light from the light projected onto the adjustment pattern, and the unit calculating displacement of landing positions based on an attenuated signal of the regular reflection light output from the reading unit and correcting the landing positions of the droplets, by controlling discharge of droplets to have the maximum diffuse reflectance of droplets constituting the adjustment pattern, it is possible to improve output sensitivity of the light receiving unit (sensor) and to improve reading capability such as detection capability of displacement, accuracy of repetition, and the like.

In this case, by controlling the droplet discharging unit such that the area generating diffuse reflection (the diffuse reflectance of a droplet) is maximized in an independent droplet, it is possible to further improve detection sensitivity and detection accuracy. In order to maximize the area generating diffuse reflection, preferably, (1) the discharge amount of the droplet is controlled, (2) the discharge amount of the droplet is controlled depending on the color thereof, (3) a time difference between when droplets are discharged to form the pattern and when a light is emitted/received to read the pattern is controlled to be minimized, and further the droplet discharge and the light emission/reception are controlled to be performed at one time, (4) a combination of materials of the conveying belt and droplets are selected such that a contact angle between the surface of the conveying belt and the droplet is large, (5) the droplet in contact with the surface of the conveying belt has a circular shape or a gourd shape, and (6) the droplet discharge is controlled such that the area of droplets substantially independent of one another is maximized in the range allowing detection by the light emitting unit and the light receiving unit. For example, the arrangement of droplets is controlled to have a minimum space between the droplets.

In the following, formation and detection of the adjustment pattern 400 is described. As mentioned above, the shape of the ink droplet is changed with the passage of time after the ink droplet is attached to the belt surface because moisture in the droplet evaporates and the regular reflection light is increased with the passage of time immediately after the droplet is formed. Accordingly, an output voltage of the pattern reading sensor 401 is reduced.

Thus, in order to accurately detect the landing positions of the ink droplets, preferably, the adjustment pattern 400 is detected by the pattern reading sensor 401 immediately after the adjustment pattern 400 is formed. In view of this, a printing speed for forming the adjustment pattern 400 and a speed for reading the adjustment pattern 400 are set to be the same speed, so that while the adjustment pattern 400 is being printed, a position of the pattern 400 is detected by the pattern reading sensor 401. In order to perform such processing, the pattern reading sensor 401 is disposed upstream in the scanning direction when the carriage 23 prints the adjustment pattern 400. However, this structure deals with only the going path or the returning path.

In view of this, the printing speed for forming the adjustment pattern 400 and the speed for reading the adjustment pattern 400 are set to be different speeds and the adjustment pattern 400 is printed on the belt surface in the going path and the returning path. Further, the adjustment pattern 400 is detected without rotating the conveying belt 31. In this case, the pattern reading sensor 401 is disposed above a formation field of the adjustment pattern 400.

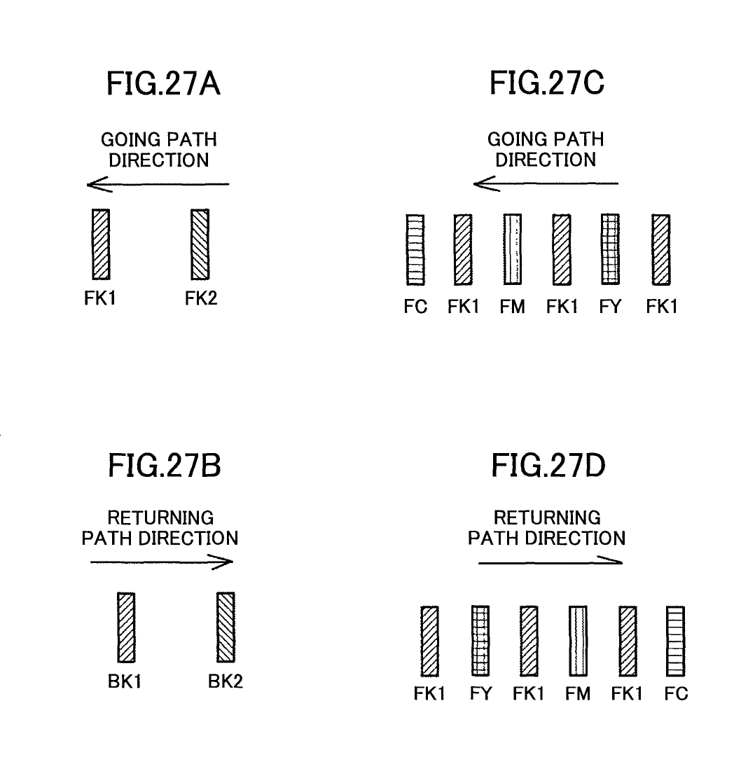

The following describes a minimum block pattern (hereafter also referred to as a basic pattern) for each detection item with reference to FIGS. 27A, 27B, 27C, and 27D which is used to detect displacement of landing positions and constitutes the adjustment pattern 400 according to the present invention.

As mentioned above, in a method for correcting the displacement of landing positions in the image forming apparatus, the recording head (color) used as a reference forms a pattern having a line-like shape in a direction orthogonal relative to a feed direction of the conveying belt, the line-like shape extending in the feed direction. Other recording head (color) forms the same line-like shape at a certain interval to calculate (measure) a distance from the reference head.

The minimum block pattern (basic pattern) for each detection item has four types including, a pattern in which a pattern FK1 formed by the recording head 24k1 in the going path (a first scan) is used as a reference and displacement of a landing position of a pattern FK2 formed by the recording head 24k2 is detected as shown in 27A, a pattern in which a pattern BK1 formed by the recording head 24k1 in the returning path (a second scan) is used as the reference and displacement of a landing position of a pattern BK2 formed by the recording head 24k2 is detected as shown in 27B, a pattern in which the pattern FK1 formed by the recording head 24k1 in the going path (a third scan) is used as the reference and displacement of landing positions of patterns FC, FM, and FY of each color (C, M, and Y) formed by the recording heads 24c, 24m, and 24y is detected as shown in 27C, and a pattern in which the pattern FK1 formed by the recording head 24k1 in the returning path (a fourth scan) is used as the reference and displacement of landing positions of the patterns FC, FM, and FY of each color (C, M, and Y) formed by the recording heads 24c, 24m, and 24y is detected as shown in FIG. 27D. When these block patterns are combined, adjustment patterns for obtaining various types of detection are constructed.

In particular, in the above-mentioned image forming apparatus, the two recording heads 24k1 and 24k2 discharging black ink are included. Accordingly, in addition to the displacement of landing positions in bidirectional printing by a single recording head, landing positions may be displaced between the two recording heads 24k1 and 24k2. In view of this, the pattern for detecting the displacement is included by which the pattern FK1 formed by the recording head 24k1 is used as the reference and the displacement of the landing position of the pattern FK2 formed by the recording head 24k2 is detected.

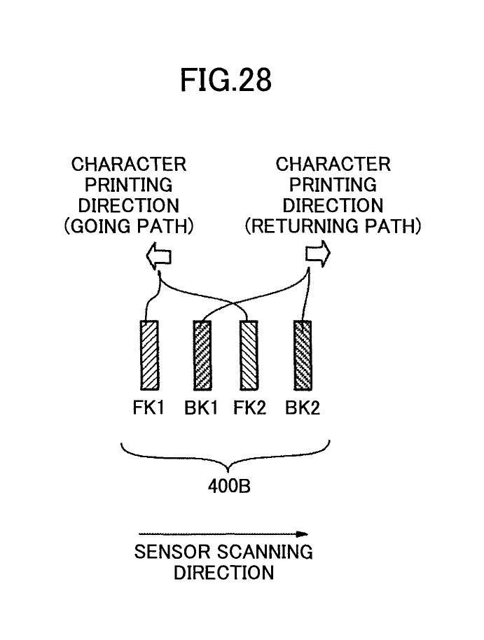

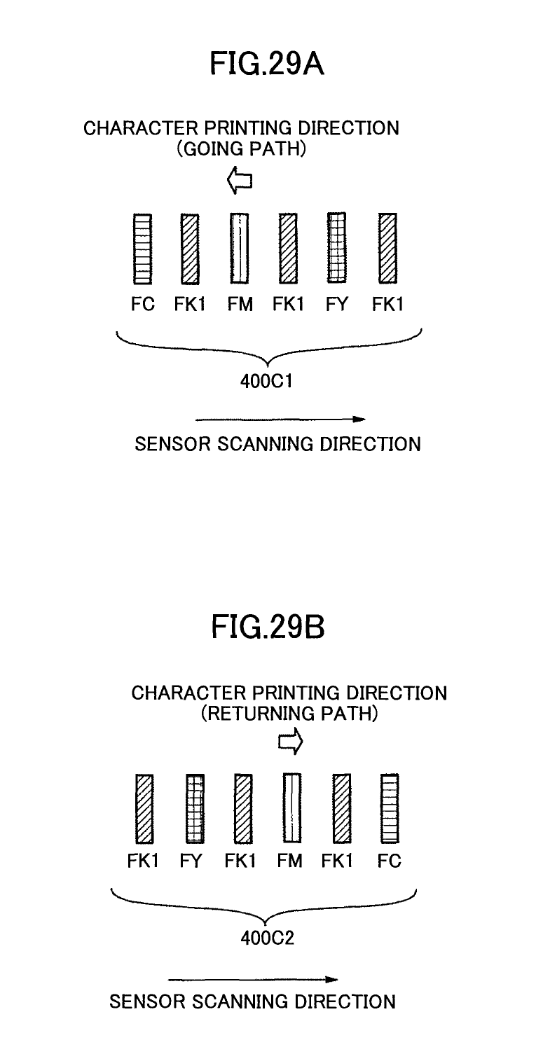

In the following, an adjustment pattern for adjusting displacement of monochrome ruled lines and an adjustment pattern for adjusting color displacement constructed using the block patterns are described with reference to FIGS. 28, 29A, and 29B.

In an adjustment pattern 400B for adjusting displacement of ruled lines shown in FIG. 28, a position of the pattern FK1 in a reference direction (the going path) is used as a reference (the pattern FK1 is used as a reference pattern), and at predetermined intervals, the pattern BK1 in the returning path, the pattern FK2 in the going path, and the BK2 in the returning path are printed (these patterns are measured). From positional information on each of these patterns FK1, BK1, FK2, and BK2, it is possible to detect displacement of landing positions relative to the pattern FK1 used as the reference pattern. The sensor scanning direction (reading direction) indicates that reading is performed only in a single direction.

In adjustment patterns 400C1 and 400C2 for adjusting color displacement shown in FIGS. 29A and 29B, relative to a color used as a reference (in this case, the pattern FK1 formed by the recording head 24k1 is used as the reference pattern), patterns FY, FM, FC of each color (these patterns are measured) are printed at specified intervals. By detecting landing positions of the pattern FK1 and FY, FK1 and FM, and FK1 and FC, it is possible to detect the landing position of each color relative to the reference pattern FK1. The sensor scanning direction indicates that reading is performed only in a single direction.

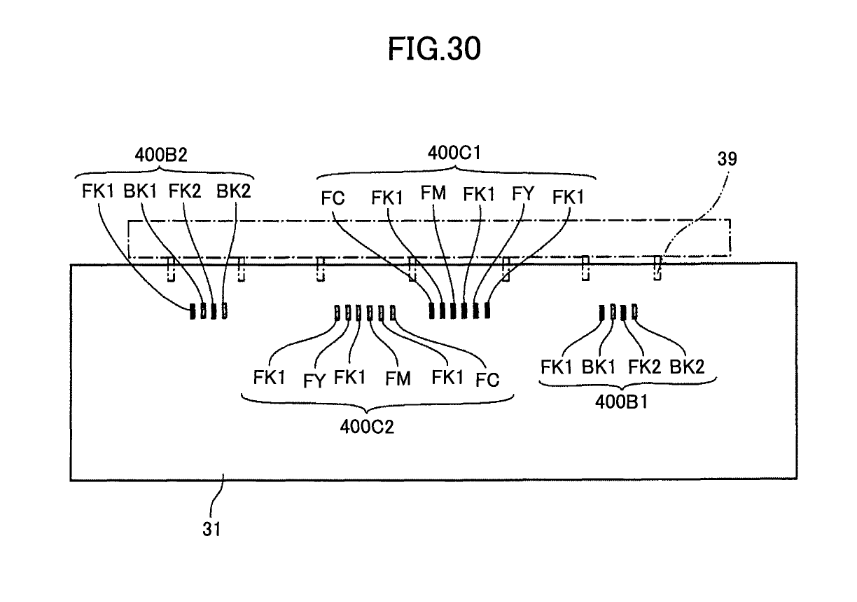

In the following, a specific example where the adjustment pattern is formed is described with reference to FIG. 30.

It is assumed that the scanning direction of the carriage 23 is determined such that a direction from a rear side of the apparatus to a front side of the apparatus is a going path direction, a direction from the front side of the apparatus to the rear side of the apparatus is a returning path direction as shown in FIG. 2, and the recording heads 24c, 24k1, 24k2, 24m, and 24y are arranged on the carriage 23 in this order from downstream (the front side) in the going path direction.

In this example, the adjustment patterns 400B1 and 400B2 for adjusting positional displacement of ruled lines are formed at both ends of the conveying belt 31 and the adjustment patterns 400C1 and 400C2 for adjusting color displacement are formed at a central portion of the conveying belt 31. In other words, in this example, plural block patterns are arranged within a width of a printing field in a direction orthogonal relative to the feed direction of the conveying belt. In this case, the block patterns are arranged on a portion having no large unevenness on the belt surface (a portion where the separation claw 39 for separating a recorded medium abuts the conveying belt 31 is not used in particular) in order to directly print the block patterns on the conveying belt 31.

Each of the adjustment patterns 400B and 400C is printed and read by the pattern reading sensor 401 plural times. In this case, it is possible to read the adjustment pattern plural times unidirectionally (the same direction) or bidirectionally.

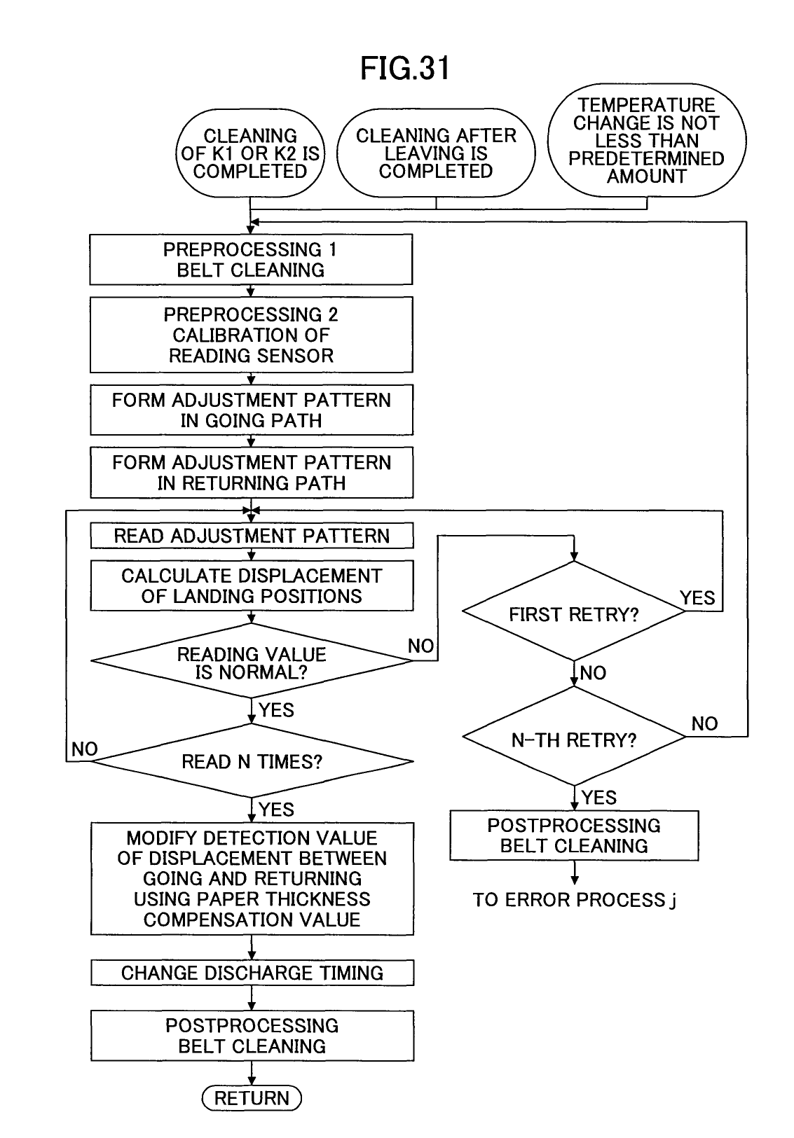

In the following, processing for adjusting (correcting) displacement of landing positions of droplets performed by the main control unit 310 is described with reference to FIG. 31.

The processing for adjusting displacement of landing positions of droplets is performed when cleaning for maintaining and recovering the recording head 24k1 or 24k2 (K1 or K2) using black ink is performed, cleaning after the apparatus is left for a predetermined period of time is performed, and an amount of a change of an environmental temperature is not less than a predetermined level.

In a preprocessing 1, the conveying belt 31 is cleaned. In a preprocessing 2, the pattern reading sensor 401 is calibrated and an output of the light emitting element 402 is adjusted such that an output level of a regular reflection light in the pattern reading sensor 401 (the light emitting element 402 and the light receiving element 403) on the carriage 23 used for scanning has a constant value relative to the conveying belt 31.

Then, while the carriage 23 performs scanning in the going path in the main scanning direction, droplets are discharged from each of the recording heads 24 to form a pattern to be formed in the going path (“F” is given to reference numerals of patterns) in the adjustment pattern (the adjustment pattern 400) shown in FIG. 30. Subsequently, while the carriage 23 performs scanning in the returning path, droplets are discharged from each of the recording heads 24 to form a pattern to be formed in the returning path (“B” is given to reference numerals of patterns) in the adjustment pattern (the adjustment pattern 400) shown in FIG. 30.

Thereafter, while the light emitting element 402 of the pattern reading sensor 401 emits a light, the carriage 23 performs scanning in the going path in the main scanning direction to read the adjustment pattern 400, so that landing positions are detected based on the output of the light receiving element 403 of the pattern reading sensor 401 and an amount of displacement of landing positions of the droplets is calculated. In this case, the linear encoder is used for controlling driving of the carriage 23 as mentioned above, so that a position of the carriage upon detecting the landing positions of the droplets is used as coordinates for discharging ink droplets. Accordingly, it is possible to acquire a theoretical value between patterns with higher accuracy.

Then, whether a read value by the pattern reading sensor 401 is normal is judged. If the read value is normal, whether to perform the reading N times is judged. If the reading is to be performed N times, the process returns to the reading process. In other words, in this case, the reading in the going path direction is repeated N times. When the N-time reading is completed, a correction value for correcting timing of droplet discharging is calculated from the amount of displacement in the going and returning paths of the carriage 23 (the amount of displacement in the going and returning paths) which is modified to compensate for paper thickness. Based on the calculated correction value for correcting the timing of droplet discharging, the timing of droplet discharging is corrected. Thereafter, in a postprocessing, the surface of the conveying belt 31 is cleaned.

If the read value by the pattern reading sensor 401 is not normal, whether a retry is a first time judged. If the retry is the first time, the adjustment pattern 400 is read again. If the retry is not the first time, whether the retry is n-th times is judged. If the retry is not the n-th times, the process returns to the processing for forming the adjustment pattern 400 again. When the retry is the n-th times, in a postprocessing, the surface of the conveying belt 31 is cleaned and process proceeds to an error processing.

In this manner, on the conveying belt which is a water-repellent member, the adjustment pattern for detecting the displacement of landing positions is formed, the adjustment pattern including the minimum block patterns for each detection item and being formed with plural droplets independent of one another. A light is projected onto the adjustment pattern and a regular reflection light from the adjustment pattern is received to read the adjustment pattern. Based on this result of the reading of the adjustment pattern, the landing positions of droplets discharged by the recording heads are corrected and the landing positions of droplets are detected with high accuracy using a simple structure, thereby correcting the displacement of the landing positions with high accuracy.

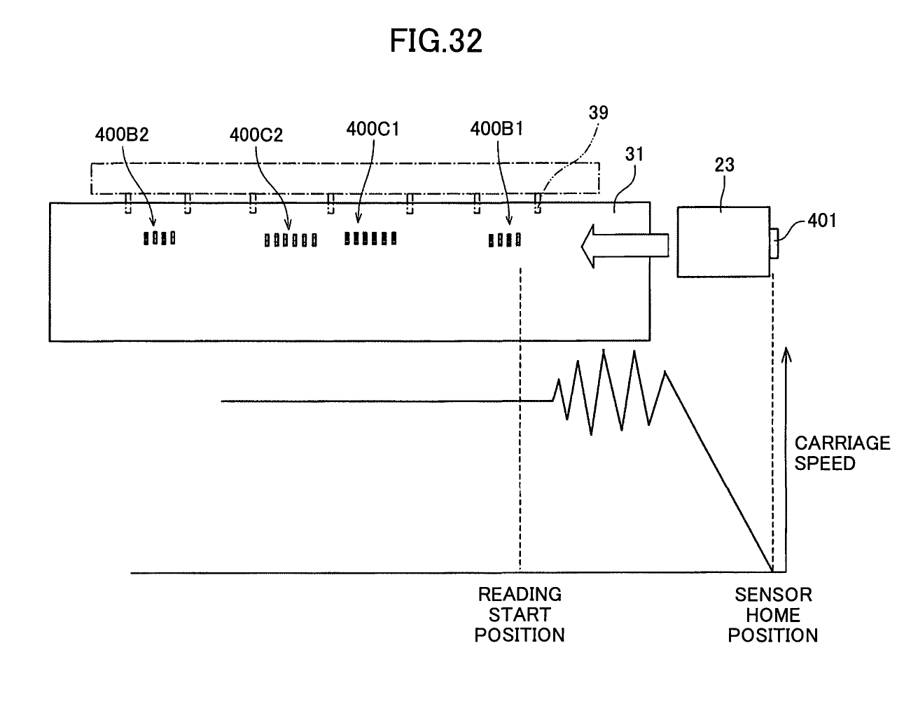

In the following, a reading speed of the pattern reading sensor 401 is described with reference to FIG. 32. The pattern reading sensor 401 is installed on the carriage 23, so that an error of reading may be increased depending on a change of a speed of the carriage 23. When the scanning by the carriage 23 is started, depending on the speed of the carriage 23, hunting may be generated from the start to a steady state (steady speed state) and the speed finally reaches a steady speed as shown in FIG. 32. When the reading is performed in this hunting, a movement distance is not increased constantly in data acquired during the hunting, so that an error may be generated. In this case, hunting time differs in accordance with the reading speed, so that a start-up distance (a distance to have the steady speed state from the start) is necessary depending on the position of the adjustment pattern 400 upon reading the adjustment pattern 400 printed on the conveying belt 31.

Accordingly, the reading is performed at a speed such that the movement speed of the carriage 23 reaches the steady speed state when the pattern reading sensor 401 reads the adjustment pattern 400. In accordance with this, it is possible to improve detection accuracy.

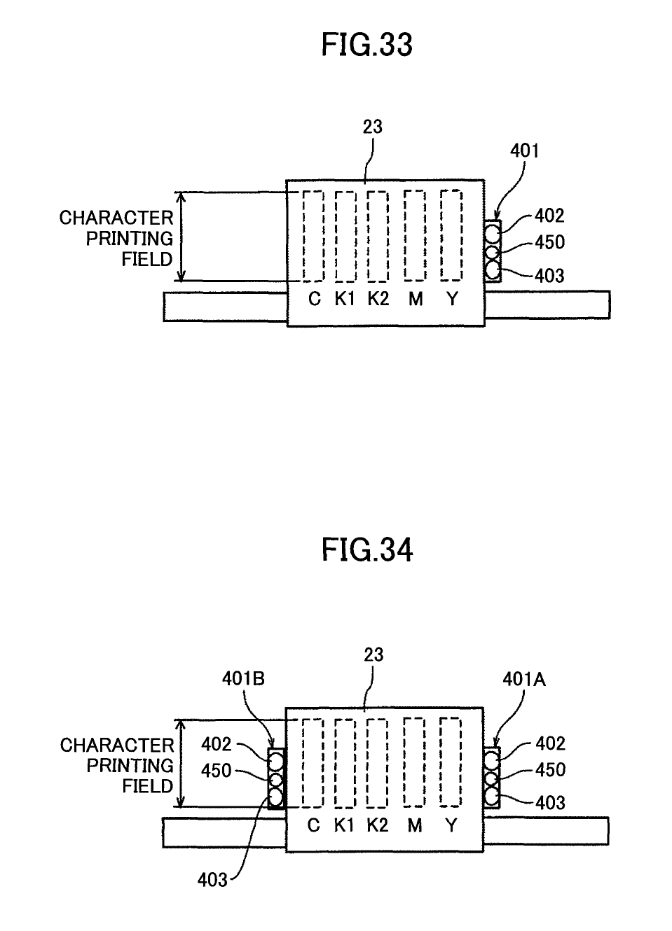

In the following, an installation position of the pattern reading sensor 401 on the carriage 23 is described with reference to FIG. 33.

The pattern reading sensor 401 is installed on the carriage 23 such that the detection range 450 is positioned within an image formation field (the printing field) by the recording heads 24 in the feed direction of the conveying belt, the recording heads 24 being installed on the carriage 23. In other words, the pattern reading sensor 401 is installed on the carriage 23 such that the detection range 450 is positioned within a range of nozzle array of the recording heads 24. Further, the pattern reading sensor 401 is installed on the carriage 23 such that the detection range is positioned within the formation field of the adjustment pattern 400 (within the sending direction). Moreover, in this example, the pattern reading sensor 401 is installed upstream in the going path direction of the carriage 23.

By constructing the carriage 23 installed on the pattern reading sensor 401 in this manner, while the recording heads 24 forms the adjustment pattern 400 on the conveying belt 31, the pattern reading sensor 401 performing scanning together with the carriage 23 (the recording heads 24) is capable of immediately reading the formed adjustment pattern 400. In this case, the reading speed of the pattern reading sensor 401 is the same as the printing speed of the adjustment pattern 400. However, only a single pattern reading sensor 401 is disposed, so that while forming the adjustment pattern 400, reading of the adjustment pattern 400 is performed in one of the going path and the returning path.

In the following, an example where two pattern reading sensors 401 are disposed on the carriage 23 is described with reference to FIG. 34.

In this case, a first pattern reading sensor 401A and a second pattern reading sensor 401B are disposed on both ends of the carriage 23 in the main scanning direction. Although it is possible to dispose these first and second pattern reading sensors 401A and 401B offset (displaced) relative to each other and to install these first and second pattern reading sensors 401A and 401B on the same position, these first and second pattern reading sensors 401A and 401B are installed such that the reading position (detection range) is positioned within the printing field range and a pattern formation field as mentioned above.

In this manner, by disposing reading units on both ends of the carriage 23, it is possible to perform bidirectional reading while printing the adjustment pattern. Further, when the reading direction and the printing direction are the same such that printing in the going path is read in the going path or printing in the returning path is read in the returning path, for example, it is possible to perform immediate reading.

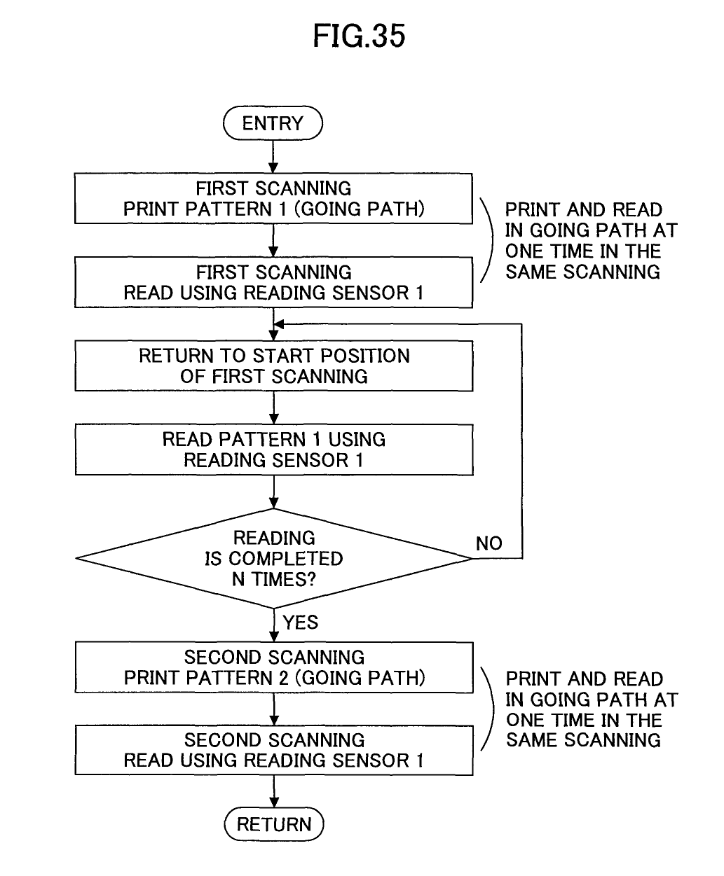

In the following, processing of unidirectional printing and unidirectional reading by a single reading sensor is described with reference to a flowchart of FIG. 35.

First, the adjustment pattern 400B (a pattern 1) for adjusting monochrome ruled lines described with reference to FIG. 28 is printed in the going path in a first scan (scanning) and the pattern 1 is read at the same time by the first pattern reading sensor 401A installed upstream relative to the recording heads 24. Next, the carriage 23 is returned to a start position of the first scan (a position before printing) and a second reading (in the same direction as in the first reading) is performed. This operation is repeated N times and the reading of the pattern 1 printed in the first scan ends.

Subsequently, the position of the carriage 23 in the main scanning direction is shifted, the adjustment pattern 400C1 (a pattern 2) for adjusting color displacement described with reference to FIG. 29A is printed in the going path in a second scan, and the pattern 2 is read at the same time by the second pattern reading sensor 401A. Next, the carriage 23 is returned to a start position of the second scan (a position before printing) and a second reading (in the same direction as in the first reading) is performed. This operation is repeated N times and the reading of the pattern 2 printed in the second scan ends. These operations are performed for each block pattern.

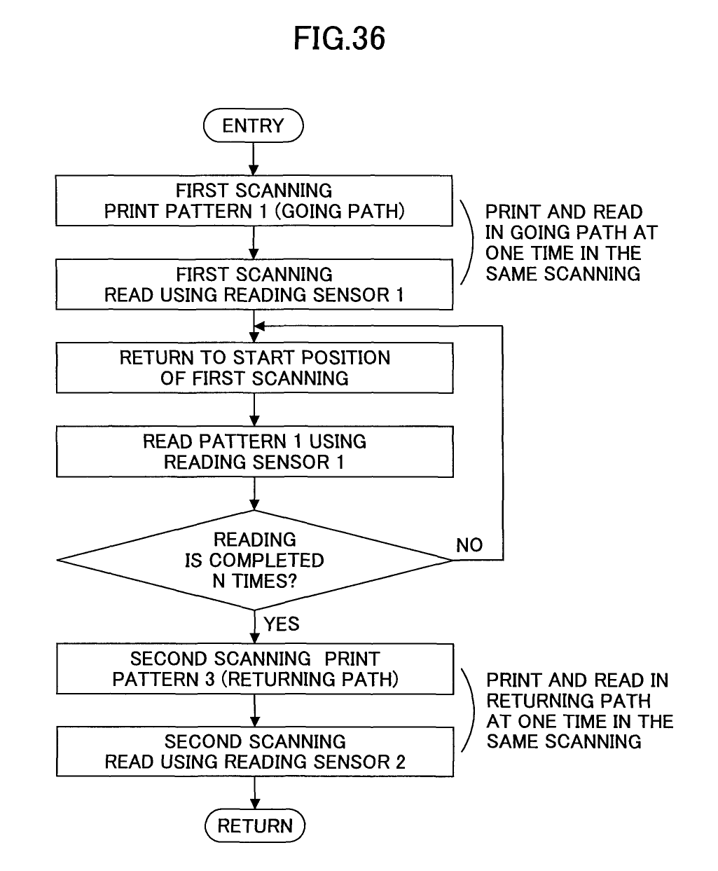

In the following, processing of bidirectional printing and bidirectional reading by two reading sensors is described with reference to a flowchart of FIG. 36.

First, the adjustment pattern 400B (the pattern 1) for adjusting monochrome ruled lines described with reference to FIG. 28 is printed in the going path in the first scan (scanning) and the pattern 1 is read at the same time by the first pattern reading sensor 401A installed upstream relative to the recording heads 24. Next, the carriage 23 is returned to the start position of the first scan (the position before printing) and the second reading (in the same direction as in the first reading) is performed. This operation is repeated N times and the reading of the pattern 1 printed in the first scan ends.

Subsequently, the position of the carriage 23 in the main scanning direction is shifted, the adjustment pattern 400C2 (a pattern 3) for adjusting color displacement described with reference to FIG. 29B is printed in the returning path in the second scan, and the pattern 3 is read at the same time by the second pattern reading sensor 401B. Next, the carriage 23 is returned to the start position of the second scan (the position before printing) and the second reading (in the same direction as in the first reading) is performed. This operation is repeated N times and the reading of the pattern 3 printed in the second scan ends. These operations are performed for each block pattern.

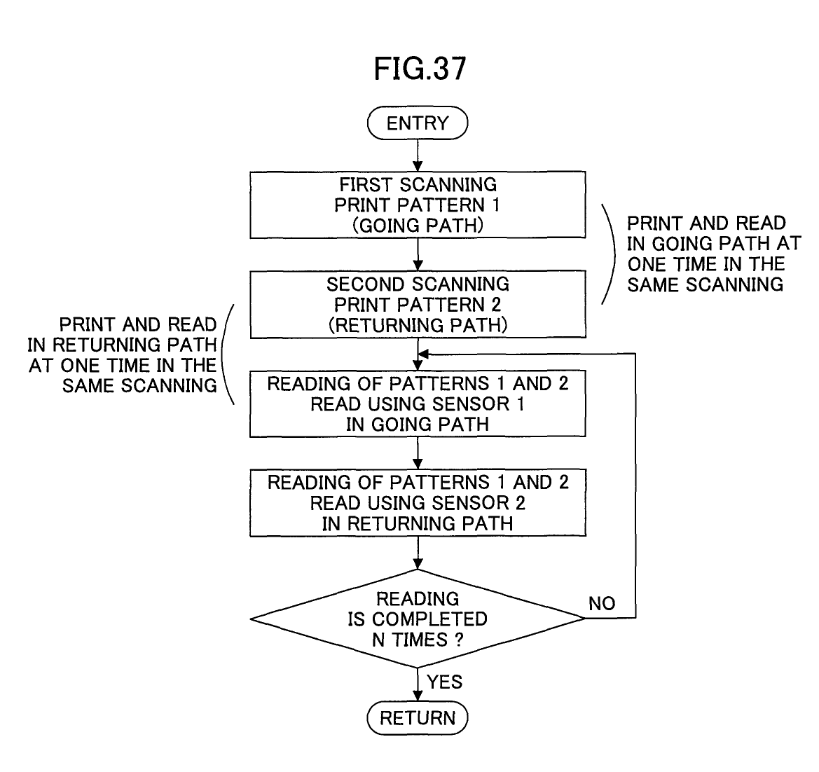

In the following, processing for bidirectionally reading a single block pattern regardless of a printing direction is described with reference to a flowchart of FIG. 37.

First, the block pattern (the pattern 1) shown in FIG. 27A is printed in the going path in the first scan and the block pattern (the pattern 2) shown in FIG. 27B is printed in the returning path in the second scan to form the adjustment pattern 400B for adjusting the monochrome ruled lines shown in FIG. 28. In the second scan, the second pattern reading sensor 401B reads the adjustment pattern 400B in the returning path. Then, the first pattern reading sensor 401A reads the same pattern in the going path and the second pattern reading sensor 401B reads the pattern in the returning path. This reading operation is repeated N times and the reading of the patterns 1 and 2 ends. When plural patterns are printed, a series of relevant operations is repeated.

In this manner, by printing the adjustment pattern for adjusting displacement of landing positions using a minimum unit (block) for each detection item and reading the adjustment pattern, a period of time from the printing to the reading is reduced, so that it is possible to prevent drying of ink droplets on the water-repellent member (the conveying belt in this case), to prevent reduction of an output of the reading sensor, and to reduce an error upon detecting the amount of displacement.

Further, the reading speed by the reading unit is the same as the speed for forming the adjustment pattern, the reading field by the reading unit is positioned within the width of the image formation field by the recording head in the conveying direction of the water-repellent member, the reading field by the reading unit is positioned within the width of the adjustment pattern in the conveying direction of the water-repellent member, and the reading direction by the reading unit disposed upstream in the scanning direction by the recording head is unidirectional. In accordance with this, the adjustment pattern is formed and read at one time, so that a period of time from the pattern formation to the pattern reading is reduced. Thus, it is possible to prevent drying of ink droplets on the conveying belt, to prevent reduction of an output of the reading sensor, and to reduce an error upon detecting the amount of displacement.

Further, the reading unit performs scanning together with the reading head, the reading head is disposed upstream and downstream in the scanning direction of the recording head, and the reading direction by the reading unit is bidirectional. In accordance with this, a period of time from the pattern formation to the pattern reading is reduced. Thus, it is possible to prevent drying of ink droplets on the conveying belt, to prevent reduction of an output of the reading sensor, and to reduce an error upon detecting the amount of displacement.

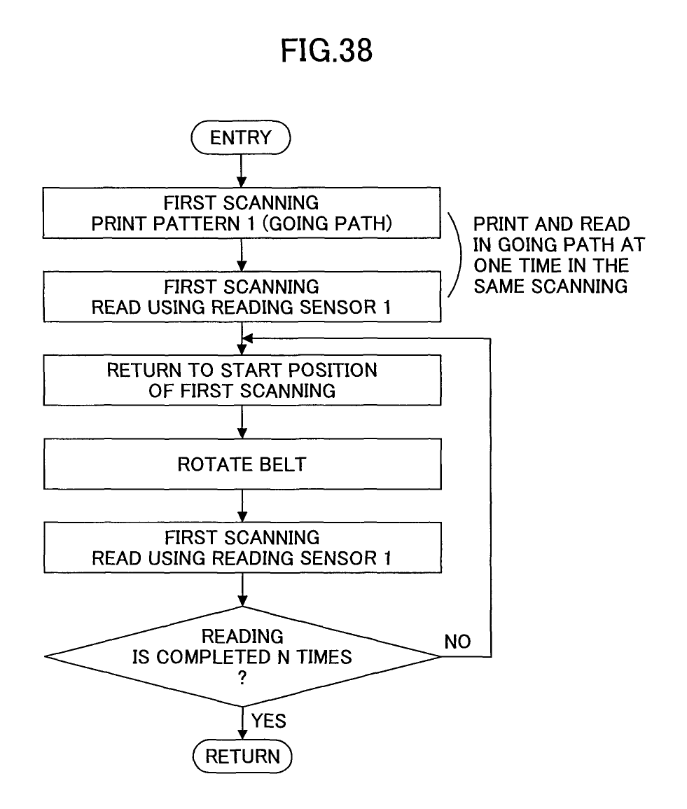

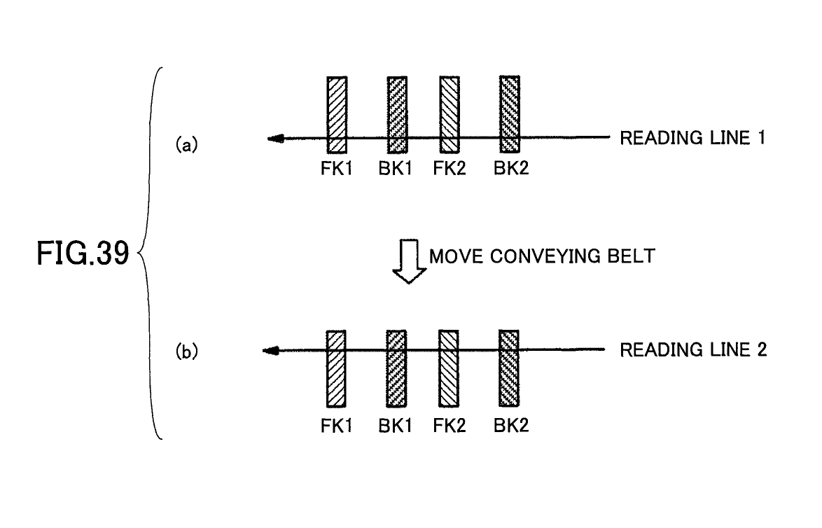

In the following, an example where the reading position of the adjustment pattern formed on the conveying belt 31 is shifted by moving the conveying belt 31 is described with reference to a flowchart in FIG. 38 and an illustration in FIG. 39.

First, the adjustment pattern 400B (the pattern 1) for adjusting monochrome ruled lines described with reference to FIG. 28 is printed in the going path in the first scan (scanning) and the pattern 1 is read at the same time by the first pattern reading sensor 401A installed upstream relative to the recording heads 24. Next, the carriage 23 is returned to the start position of the first scan (the position before printing). Thereafter, the conveying belt 31 is rotated for a predetermined amount and the second reading (in the same direction as in the first reading) is performed by the first pattern reading sensor 401A. This operation is repeated N times and the reading of the pattern 1 printed in the first scan ends.

After the reading is performed in a reading line 1 as shown in FIG. 39-(a), the conveying belt 31 is moved and a relative position between the adjustment pattern and the reading position by the reading sensor is shifted to perform reading in a reading line 2.

In this manner, after the pattern printed on the conveying belt is read unidirectionally or bidirectionally in a repeated manner, it is possible to rotate the conveying belt to shift the pattern relative to the reading line and to perform the reading again. Accordingly, it is possible to obtain plural reading results from the same pattern. Due to an increase in a measurement number, errors are averaged and measurement accuracy is improved. In addition, by moving the conveying belt as many times as possible to allow the reading, it is possible to further increase a number of data sets obtained from the reading and to improve reading accuracy (the measurement accuracy).

In the above-mentioned embodiment, although examples are described when the conveying belt is a water-repellent member, it is possible to use a sheet material having water repellency.

The present invention is not limited to the specifically disclosed embodiment, and variations and modifications may be made without departing from the scope of the present invention.

The present application is based on Japanese priority application No. 2007-070404 filed Mar. 19, 2007, the entire contents of which are hereby incorporated herein by reference.

What is claimed is:

1. An image forming apparatus for forming an image on a recording medium being conveyed, comprising:
a recording head discharging droplets;
a pattern forming unit forming an adjustment pattern for detecting displacement of landing positions of droplets on a water-repellent member, the adjustment pattern including a minimum block pattern for each detection item and being formed with plural droplets independent of one another;
a reading unit including a light emitting unit projecting a light onto the adjustment pattern and a light receiving unit receiving a regular reflection light from the adjustment pattern; and
a landing position correcting unit correcting the landing positions of the droplets discharged from the recording head based on a result of reading by the reading unit.

2. The image forming apparatus according to claim 1, wherein
the minimum block pattern for each detection item is a pattern for detecting displacement of a ruled line or displacement of color relative to a reference.

3. The image forming apparatus according to claim 1, wherein
a plurality of the block patterns for each detection item are formed and arranged in a width direction of a printable field.

4. The image forming apparatus according to claim 1, wherein
the block pattern is read by the reading unit in each formation of the block pattern.

5. The image forming apparatus according to claim 1, wherein
the block pattern is read by the reading unit plural times in each formation of the block pattern.

6. The image forming apparatus according to claim 1, wherein
a reading speed of the reading unit is variably controlled.

7. The image forming apparatus according to claim 6, wherein
the reading speed is controlled in accordance with a formation position of the block pattern.

8. The image forming apparatus according to claim 1, wherein
the reading speed of the reading unit is the same as a speed for forming the adjustment pattern.

9. The image forming apparatus according to claim 8, wherein
a reading field of the reading unit is positioned within a width of an image formation field of the recording head in a conveying direction of the water-repellent member.

10. The image forming apparatus according to claim 9, wherein
the reading field of the reading unit is positioned within a width of the adjustment pattern in the conveying direction of the water-repellent member.

11. The image forming apparatus according to claim 8, wherein
the reading unit performs scanning together with the recording head and is disposed upstream in a scanning direction of the recording head.

12. The image forming apparatus according to claim 11, wherein
a reading direction of the reading unit is unidirectional.

13. The image forming apparatus according to claim 8, wherein
the reading unit performs scanning together with the recording head and is disposed upstream and downstream in a scanning direction of the recording head.

14. The image forming apparatus according to claim 13, wherein
a reading direction of the reading unit is bidirectional.

15. The image forming apparatus according to claim 1, wherein
the adjustment pattern is read plural times by the reading unit.

16. The image forming apparatus according to claim 15, wherein
while the adjustment pattern is read plural times, a reading position is shifted at least once.

17. The image forming apparatus according to claim 1, wherein
the water-repellent member is a conveying belt conveying the recording medium.

18. A method for correcting displacement of landing positions of droplets discharged from a recording head, comprising the steps of:
forming an adjustment pattern for detecting the displacement of landing positions of the droplets on a water-repellent member, the adjustment pattern including a minimum block pattern for each detection item and being formed with plural droplets independent of one another;
projecting a light onto the adjustment pattern and receiving a regular reflection light from the adjustment pattern to read the adjustment pattern; and
correcting the landing positions of the droplets discharged from the recording head based on a result of the reading by the reading unit.
